(19) United States
(12) Patent Application Publication
(10) Pub. No.: US 2023/0288773 A1
(43) Pub. Date: Sep. 14, 2023

(54) METHODS AND SYSTEMS FOR RECONFIGURABLE HYBRID METASURFACES

(71) Applicant: Georgia Tech Research Corporation, Atlanta, GA (US)

(72) Inventors: Sajjad Abdollahramezani, Atlanta, GA (US); Ali Adibi, Atlanta, GA (US); Omid Hemmatyar, Atlanta, GA (US); Hossein Taghinejad, Atlanta, GA (US)

(21) Appl. No.: 18/005,681

(22) PCT Filed: Jul. 30, 2021
(86) PCT No.: PCT/US2021/043852

§ 371 Date: Jan. 17, 2023

Related U.S. Application Data
(60) Provisional application No. 63/059,326, filed on Jul. 31, 2020.

(51) Int. Cl. G02F 1/19

(52) U.S. Cl. CPC G02F 1/19; G02F 2203/10; G02F 2202/30; G02F 2201/50

(57) ABSTRACT

An exemplary embodiment of the present disclosure provides a reconfigurable hybrid metal-dielectric metasystem having a phase change material configured to reversibly transform between an amorphous state and a crystalline state upon a triggering event. The phase change material can be abutting a dielectric material on a first surface of the phase change material and a plasmonic material on an opposing second surface of the phase change material. An additional embodiment of the system includes when light travels through the system, the phase change material in the amorphous state can be configured to absorb a range of light, whereas the phase change material in the crystalline state can be configured to reflect the same range of light.

### CROSS-REFERENCE TO RELATED APPLICATIONS

This application claims the benefit of U.S. Provisional Application Ser. No. 63/059,326, filed on 31 Jul. 2020, which is incorporated herein by reference in its entirety as if fully set forth below.

### FEDERALLY SPONSORED RESEARCH STATEMENT

This invention was made with government support under grant/award number N00014-18-1-2055 awarded by the Office of Naval Research. The government has certain rights in the invention.

### FIELD OF THE DISCLOSURE

The various embodiments of the present disclosure relate generally to optical metasurfaces, and more particularly to hybrid metal-dielectric meta-atoms for flat optics.

### BACKGROUND

Conventional optical lenses rely on curvature of refractive materials to manipulate optical wavefronts spectrally, spatially, and temporally via gradual phase accumulation and amplitude modification. Optical metasurfaces are devices with planar surfaces that incorporate subwavelength-scale optical components, such as patterned nanostructures, or “nano scatterers,” to phase shift light. In general, metamaterials can modulate an optical signal such that the amplitude or phase of the light wave is substantially changed by modulating the refractive index or absorption coefficient of the metamaterial.

Although there are many optical metasurfaces, many of these prior art systems suffer from efficiency problems and generate heat that can be damaging to the system. Prior art systems have either all-plasmonic (metallic-based) nano scatterers or all-dielectric nano scatterers. All-dielectric nano scatterer systems can exhibit high radiation efficiencies but often experience lower coupling efficiency. In general, the all-plasmonic or all-dielectric systems alone fail to address the nonradiative losses, limited scattering cross-section, high quality factor modes, and CMOS-compatibility. Employing a hybrid metal-dielectric metasurface can offer enhanced properties to flat optics by taking advantage of the highly directional radiation patterns while preserving high coupling efficiency and moderate dissipation loss. When light travels through the hybrid metal-dielectric metasurface, light will be scattered through the dielectric portion to generate an electric field peak and a magnetic resonance, while the plasmonic back reflector will generate a surface plasmon polariton mode along the metal-dielectric interface. In addition, a hybrid metal-dielectric system can further incorporate phase change materials, or substances that can reversibly transition between multiple states upon heating and cooling, to allow the metasurface and the optical system to be reconfigurable. Although all-dielectric or all-plasmonic systems have incorporated PCMs, the prior art systems have not yet incorporated PCMs into hybrid metal-dielectric systems. Therefore, there is a need for highly integrated, energy efficient, easy-to-fabricate, and low-cost reconfigurable hybrid meta-atoms for creating fast and efficient reconfigurable metasurfaces. It is an object of at least one aspect of the present disclosure to provide an improved metasurface system comprising a hybrid metal-dielectric metasurface with reconfigurable phase change materials.

### BRIEF SUMMARY

Combining phase change materials into the hybrid metal-dielectric metasurface allows for active control of the scattering properties of a hybrid metal-dielectric metasurface with enhanced dynamic range and efficiency of the reconfiguration process with the ability to control arbitrary transformations in amplitude, phase, and even polarization of the incident optical wavefront for applications in light detection and ranging (LiDAR), infrared sensors, energy harvesting, computational meta-systems and optical sensing. Metasurfaces can have multiple applications based on polarization control and wavefront shaping, including, without limitation, half-wave plate, quarter-wave plate, polarimetry, optical vortex conversion, meta-hologram, and planar lens.

The present disclosure relates to reconfigurable hybrid metal-dielectric metasystems. An exemplary embodiment of the present disclosure provides a system having a phase change material configured to reversibly transform between a first state and a second state upon a triggering event. The phase change material can be abutting a dielectric material on a first surface of the phase change material and a plasmonic material on an opposing second surface of the phase change material.

In any of the embodiments disclosed herein, the phase change material in the first state can have a first refractive index. The phase change material in the second state can have a second refractive index. The first refractive index can be different than the second refractive index.

In any of the embodiments disclosed herein, when light travels through the system, the phase change material in the first state can be configured to absorb a range of light. When light travels through the system, the phase change material in the second state can be configured to reflect the range of light.

In any of the embodiments disclosed herein, when light travels through the system, the phase change material can be configured to modulate an amplitude of light in a wavelength range when in the first state. The phase change material can be configured to modulate the amplitude of light in the wavelength range when in the second state. The first state of the phase change material can modulate the amplitude of light in the wavelength range different than the second state.

In any of the embodiments disclosed herein, the phase change material can further be configured to transform to one or more intermediate states between the first state and the second state. Each of the one or more intermediate states can have a refractive index different than the first and second refractive indices.

In any of the embodiments disclosed herein, the triggering event can include a thermal, electrical, or optical stimulus.

In any of the embodiments disclosed herein, the triggering event can include heat, current, voltage, or electromagnetic field directed to the system.

In any of the embodiments disclosed herein, the phase change material can have a height ranging from about 20 nm to about 200 nm. The dielectric material can have a height ranging from about 50 nm to about 250 nm. The plasmonic material can have a height ranging from about 80 nm to about 200 nm.

In any of the embodiments disclosed herein, the system can further include a first protective layer located at the first surface between the phase change material between the phase change material and the dielectric material. The first protective layer can have a height ranging from about 5 nm to about 50 nm.

In any of the embodiments disclosed herein, the system can include a second protective layer located at the second surface of the phase change material between the phase change material and the plasmonic material. The second protective layer can have a height ranging from about 5 nm to about 50 nm.

In any of the embodiments disclosed herein, the system can include a third protective layer bordering the dielectric material on an external surface opposite the phase change material. The third protective layer can have a height ranging from about 30 nm to about 150 nm.

In any of the embodiments disclosed herein, the dielectric material can be arranged in an array of nano-scatterers on the first surface of the phase change material. The array of nano-scatterers have a period ranging from about 100 nm to about 1000 nm. The array of nano-scatterers can have a radius ranging from about 10 nm to about 500 nm.

In any of the embodiments disclosed herein, the phase change material can include a solid-solid phase change material. The phase change material can include a combination of germanium, antimony, and tellurium.

In any of the embodiments disclosed herein, the phase change material can include a combination of germanium, antimony, selenium, and tellurium.

In any of the embodiments disclosed herein, the phase change material can include a combination of two or more materials from the group consisting of germanium, antimony, and tellurium, selenium, indium, titanium, gallium, bismuth, tin, copper, lead, palladium, silver, sulfur, vanadium, and gold.

In any of the embodiments disclosed herein, the phase change material can include a polymeric solid-solid phase change material. The phase change material can include a combination of two or more materials selected from the group consisting of polystyrene, cellulose, polyethylene glycol), styrene acrylonitrile, poly(styrene-co-allyalcohol), sorbitol, dipentaerythritol, inositol, melamine, formaldehyde, polyethyl eneglycol, polyethylene oxide, carboxymethyl cellulose, polyvinyl alcohol, and poly(polyethylene glycol methyl ether methacrylate).

In any of the embodiments disclosed herein, the phase change material can include an organometallic solid-solid phase change material.

In any of the embodiments disclosed herein, the dielectric material can be selected from the group consisting of silicon, silicon carbide, silicon nitride, aluminum nitride, germanium, alumina, gallium nitride, hafnium oxide, zirconium oxide, titanium dioxide, indium tin oxide, lithium niobate, silicon dioxide, gallium phosphate, gallium arsenide, hafnium silicate, zirconium silicate, strontium titanate, barium titanate, barium strontium titanate, calcium copper titanate, silsesquioxane, hydrogen silsesquioxane, polyethylene, polypropylene, polystyrene, and polytetrafluoroethylene.

In any of the embodiments disclosed herein, the plasmonic material can be a metal selected from the group consisting of gold, silver, aluminum, bismuth, copper, palladium, titanium, and tungsten. The plasmonic material can also be a material selected from the group consisting of titanium nitride, indium phosphide, aluminum-zinc-oxide, gallium-zinc-oxide, indium-tin-oxide, and indium nitride.

An exemplary embodiment of the present disclosure provides a system having an array of structures positioned over a metal substrate. The array of structures can include a phase change material layer configured to interface with the array of structures on a first surface, interface with the metal substrate on an opposing second surface, and reversibly transition, upon a triggering event, from a first state, along a series of intermediate states, to a second state.

In any of the embodiments disclosed herein, the array of structures can further include a first row of structures comprising a first radius and a second row of structures comprising a second radius, wherein the first radius is different than the second radius.

In any of the embodiments disclosed herein, the phase change material layer in the first state can have a first refractive index. The phase change material layer in the second state can have a second refractive index. The phase change material layer in an intermediate state can have a refractive index different than the first and second refractive indices, where the first refractive index is different than the second refractive index.

In any of the embodiments disclosed herein, when light travels through the system, the phase change material layer in the first state can be configured to modulate a phase of light in a wavelength range. Additionally, the phase change material layer in the second state can be configured to modulate the phase of light in the wavelength range. The first state of the phase change material layer can modulate the phase of light in the wavelength range different than the second state.

In any of the embodiments disclosed herein, when light travels through the system, the phase change material layer in the first state can further be configured to shift the phase of the wavelength of light by an increment of about 90 degrees.

In any of the embodiments disclosed herein, the wavelength of light can range from about 1530 nm to about 1565 nm.

In any of the embodiments disclosed herein, the triggering event can include heat, current, voltage, or electromagnetic field directed to the system.

In any of the embodiments disclosed herein, the array of structures can include a height ranging from about 50 nm to about 250 nm. The phase change material layer can include a height ranging from about 20 nm to about 200 nm. The metal substrate can include a height ranging from about 80 nm to about 200 nm.

In any of the embodiments disclosed herein, the system can further include a first protective layer located between the first surface of the phase change material layer and the array of structures. The system can also include a second protective layer located between the second surface of the phase change material layer and the metal substrate.

In any of the embodiments disclosed herein, the first protective layer and the second protective layer can each independently include a height ranging from about 5 nm to about 50 nm.

In any of the embodiments disclosed herein, the system can further include a third protective layer bordering the array of structures.

In any of the embodiments disclosed herein, the third protective layer can include a height ranging from about 30 nm to about 150 nm.

In any of the embodiments disclosed herein, the array of structures can include a dielectric material selected from the group consisting of silicon, silicon carbide, silicon nitride, aluminum nitride, germanium, alumina, gallium nitride, hafnium oxide, zirconium oxide, titanium dioxide, indium tin oxide, lithium niobate, silicon dioxide, gallium phosphate, gallium arsenide, hafnium silicate, zirconium silicate, strontium titanate, barium titanate, barium strontium titanate, calcium copper titanate, silsesquioxane, hydrogen silsesquioxane, polyethylene, polypropylene, polystyrene, and polytetrafluoroethylene.

In any of the embodiments disclosed herein, the phase change material layer can include a combination of two or more materials from the group consisting of germanium, antimony, and tellurium, selenium, indium, titanium, gallium, bismuth, tin, copper, lead, palladium, silver, sulfur, vanadium, and gold.

In any of the embodiments disclosed herein, the metal substrate can be a plasmonic material selected from the group consisting of gold, silver, aluminum, bismuth, copper, palladium, aluminum-zinc-oxide, gallium-zinc-oxide, indium-tin-oxide, titanium nitride, titanium, and tungsten.

An exemplary embodiment of the present disclosure provides a system including an array of meta-atoms positioned over a plasmonic substrate. Each meta-atom can include a dielectric nanodisk positioned over a phase change material.

In any of the embodiments disclosed herein, the phase change material can be configured to reversibly transform from a crystalline state to an amorphous state upon external stimulation.

In any of the embodiments disclosed herein, the phase change material in the amorphous state can have a first refractive index. The phase change material in the crystalline state can have a second refractive index. The first refractive index can be different than the second refractive index.

In any of the embodiments disclosed herein, a meta-atom in the array of meta-atoms can have a radius about equal to an adjacent meta-atom.

In any of the embodiments disclosed herein, when light travels through the system, the array of meta-atoms can be configured to absorb a range of light when the phase change material is in the amorphous state. Additionally, the array of meta-atoms can be configured to reflect the range of light when the phase change material is in the crystalline state.

In any of the embodiments disclosed herein, when light travels through the system, the array of meta-atoms can be configured to modulate an amplitude of a wavelength of light by a first degree when the phase change material is in the amorphous state. Additionally, the array of meta-atoms can be configured to modulate the amplitude of the wavelength of light by a second degree when the phase change material is in the crystalline state, wherein the first degree of modulation is different than the second degree of modulation.

In any of the embodiments disclosed herein, the array of meta-atoms can include a first row of meta-atoms having a first radius and a second row of meta-atoms having a second radius different than the first radius.

In any of the embodiments disclosed herein, when light travels through the system, the array of meta-atoms can be configured to modulate a phase of light in a wavelength range by a first degree when the phase change material is in the amorphous state. The array of meta-atoms can be configured to modulate the phase of light in the wavelength range by a second degree when the phase change material is in the crystalline state. The first degree of modulation can be different than the second degree of modulation.

In any of the embodiments disclosed herein, when light travels through the system, the array of meta-atoms can be configured to shift a phase of a wavelength of light by an increment of about 90 degrees when the phase change material is in the amorphous state. The array of meta-atoms can be configured to shift the phase of the wavelength of light by about 0 degrees when the phase change material is in the crystalline state.

In any of the embodiments disclosed herein, the dielectric nanodisk can include a dielectric material selected from the group consisting of silicon, silicon carbide, silicon nitride, aluminum nitride, germanium, alumina, gallium nitride, hafnium oxide, zirconium oxide, titanium dioxide, indium tin oxide, lithium niobate, silicon dioxide, gallium phosphate, gallium arsenide, hafnium silicate, zirconium silicate, strontium titanate, barium titanate, barium strontium titanate, calcium copper titanate, silsesquioxane, hydrogen silsesquioxane, polyethylene, polypropylene, polystyrene, and polytetrafluoroethylene.

In any of the embodiments disclosed herein, the phase change material can include a combination of two or more materials from the group consisting of germanium, antimony, and tellurium, selenium, indium, titanium, gallium, bismuth, tin, copper, lead, palladium, silver, sulfur, vanadium, and gold.

In any of the embodiments disclosed herein, the plasmonic substrate can be a plasmonic material selected from the group consisting of gold, silver, aluminum, bismuth, copper, palladium, aluminum-zinc-oxide, gallium-zinc-oxide, indium-tin-oxide, titanium nitride, titanium, and tungsten.

In any of the embodiments disclosed herein, the system can further include a heater layer positioned below the plasmonic substrate and configured to deliver external stimulation to the array of meta-atoms.

In any of the embodiments disclosed herein, the heater layer can be a material selected from the group consisting of tungsten, titanium, copper, silicon, silver, gold, titanium nitride, niobium, molybdenum, tantalum, chromium, and indium tin oxide.

In any of the embodiments disclosed herein, the external stimulation can include heat, current, voltage, or electromagnetic field directed to the system.

An exemplary embodiment of the present disclosure provides a method for manufacturing a system. The method can include providing a plasmonic substrate, depositing a phase change material over the plasmonic substrate, depositing a dielectric material over the phase change material, exposing at least a portion of the phase change material and plasmonic substrate, and forming, through etching, the dielectric material into an array of pillars.

In any of the embodiments disclosed herein, the method can further include forming a symmetric array of pillars having identical radii, transmitting a wavelength of light in a path normal to the array of pillars, receiving a first optical response when the wavelength of light is absorbed by the system when the phase change material is in the amorphous state.

In any of the embodiments disclosed herein, the method can further include stimulating the system to transform the phase change material from the amorphous state to a crystalline state, transmitting the wavelength of light in a path normal to the array of pillars, and receiving a second optical response when the wavelength of light is reflected by the system when the phase change material is in the crystalline state.

In any of the embodiments disclosed herein, the method can further include forming the array of pillars wherein a first pillar has a radius different than an adjacent pillar.

In any of the embodiments disclosed herein, the method can further include stimulating the system to transform a phase change material from the amorphous state to a crystalline state, transmitting a wavelength of incident light to the array of pillars, and receiving a third optical response when the phase of the wavelength of incident light is shifted by the system when the phase change material is in the crystalline state.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1A provides an example of a conventional PCM-dielectric meta-atoms, in accordance with an exemplary embodiment of the present disclosure.

FIG. 1B provides an example of a conventional PCM-metal meta-atoms, in accordance with an exemplary embodiment of the present disclosure.

FIG. 2A provides an example of a hybrid PCM metal-dielectric metasurface, in accordance with an exemplary embodiment of the present disclosure.

FIG. 2B provides an example of a hybrid PCM metal-dielectric metasurface, in accordance with an exemplary embodiment of the present disclosure.

FIG. 3A provides an example of a hybrid PCM metal-dielectric metasurface, in accordance with an exemplary embodiment of the present disclosure.

FIG. 3B provides an example of a hybrid PCM metal-dielectric metasurface, in accordance with an exemplary embodiment of the present disclosure.

FIG. 4A provides an example cross sectional view of a meta-atom consisting of a dielectric nanodisk on a phase change material film laid on top of an optically-thick plasmonic material substrate, in accordance with an exemplary embodiment of the present disclosure.

FIG. 4B provides a generic scheme of atomic distribution of amorphous/crystalline phase change material (a-GST/c-GST) before/after thermal annealing, in accordance with an exemplary embodiment of the present disclosure.

FIG. 4C provides a dual plot of refractive index (left axis) versus wavelength (nm) and absorption coefficient (right axis) versus wavelength (nm) for different crystallization levels of phase change material (L^{0%} corresponds to the amorphous state, L^{100%} corresponds to the crystalline state, and the intermediate states are represented by the crystallization level of Lⁱ, where i is 20%, 40%, 60%, and 80%), in accordance with an exemplary embodiment of the present disclosure.

FIG. 5A provides a perspective view of an example meta-switch illuminated by a broadband near-IR light, in accordance with an exemplary embodiment of the present disclosure.

FIG. 5B provides the evolution of fundamental plasmonic-photonic modes (including surface plasmon polariton (SPP) and magnetic dipole (MD)) upon transition of the phase change material state from amorphous to crystalline in multiple intermediate levels, in accordance with an exemplary embodiment of the present disclosure.

FIG. 6A provides a schematic of an example meta-deflector illuminated with a laser light, in accordance with an exemplary embodiment of the present disclosure.

FIG. 6B provides the spectral response of each dielectric nanodisk sketched in the separated meta-molecule in FIG. 6A, in accordance with an exemplary embodiment of the present disclosure.

FIG. 7A provides a schematic of the excited strong SPP mode that interacts with the electric dipole mode in an example amorphous phase change material, in accordance with an exemplary embodiment of the present disclosure.

FIG. 7B provides the two-dimensional (2D) reflection maps for an example amorphous phase change material in FIG. 7A as functions of metasurface period (p) and wavelength (λ), in accordance with an exemplary embodiment of the present disclosure. The gray-scale dotted line represents the electric field enhancement induced by the electric dipole resonance at the gap center between two neighbor meta-atoms.

FIG. 8A provides a schematic of the enhanced MD interferes with the SPP mode in an example crystalline phase change material, in accordance with an exemplary embodiment of the present disclosure.

FIG. 8B provides the two-dimensional (2D) reflection maps for an example crystalline phase change material in FIG. 8A as functions of metasurface period (p) and wavelength (λ), in accordance with an exemplary embodiment of the present disclosure. The gray-scale dotted line represents the magnetic field enhancement induced by the MD mode at the center of the pseudo-pillar.

FIG. 9 provides an image of a tilted SEM of an example tunable meta-switch with structural parameters including a period of 650 nm, radii of 280 nm, height of plasmonic material of 100 nm, height of first and second protective material of 5 nm, height of phase change material of 75 nm, height of dielectric nanodisks of 90 nm, and height of third protective material of 70 nm, in accordance with an exemplary embodiment of the present disclosure.

FIG. 10A provides a measured spectral dependence of light reflection for three different crystallization levels of L^{0%} (i.e., a-GST), L^{40%} (stands for 40% crystallization level), and L^{100%} (i.e., c-GST) from an example meta-switch, in accordance with an exemplary embodiment of the present disclosure.

FIG. 10B provides a simulated spectral dependence of light reflection for three different crystallization levels of L^{0%} (i.e., a-GST), L^{40%} (stands for 40% crystallization level), and L^{100%} (i.e., c-GST) from an example meta-switch, in accordance with an exemplary embodiment of the present disclosure.

FIGS. 11A through 11C provide distribution of electromagnetic fields at the fundamental resonances of the three different crystallization levels shown in FIG. 10B of L^{0%} (FIG. 11A), L^{40%} (FIG. 11B), and L^{100%} (FIG. 11C) from an example meta-switch, in accordance with an exemplary embodiment of the present disclosure.

FIGS. 12A through 12C provide spectral dependence of light reflection and distribution of electromagnetic fields at the fundamental resonances of three different crystallization levels of L^{20%} (FIG. 12A), L^{60%} (FIG. 12B), and L^{80%} (FIG. 12C) from an example meta-switch, in accordance with an exemplary embodiment of the present disclosure.

FIG. 13A provides a real part of the magnetic field in the x-y plane 5 nm above the metal substrate in an example meta-atom, in accordance with an exemplary embodiment of the present disclosure.

FIG. 13B provides an electric field intensity in the x-z plane in an example meta-atom with a phase change material in the amorphous state (L^{0%}) at the resonant wavelength associated with the reflection dip shown in FIG. 10A, in accordance with an exemplary embodiment of the present disclosure.

FIGS. 14A and 14B provide schematic illustrations of example experimental setup for IR reflectometry and back focal plane imaging, with a lens K-space inserted for beam deflection measurement (FIG. 14A), or signal generators for co-located electrical programming coupled to optical characterization (FIG. 14B), in accordance with an exemplary embodiment of the present disclosure.

FIG. 15 provides a time instant of scattered magnetic fields, reflectivity evolution (left axis), and phase shift (right axis) from four constitutive meta-atoms (A, B, C, and D) of an example meta-deflector shown in FIG. 6A illuminated by a normally x-polarized plane wave at λ=1550 nm for a phase change material in an amorphous state meta-atom, in accordance with an exemplary embodiment of the present disclosure.

FIG. 16 provides a time instant of scattered magnetic fields, reflectivity evolution (left axis), and phase shift (right axis) from four constitutive meta-atoms (A, B, C, and D) of an example meta-deflector shown in FIG. 6A illuminated by a normally x-polarized plane wave at λ=1550 nm for a phase change material in a crystalline state, in accordance with an exemplary embodiment of the present disclosure.

FIG. 17 provides a top view SEM of four constitutive meta-atoms (A, B, C, and D) of an example meta-deflector shown in FIG. 6A, in accordance with an exemplary embodiment of the present disclosure.

FIG. 18A provides a simulated 2D map for angular and spectral responses of an example meta-deflector for a phase change material in an amorphous state, in accordance with an exemplary embodiment of the present disclosure.

FIG. 18B provides a measured normalized far-field radiation measured from a CCD camera for three different incident wavelengths covering the C-band of an example meta-deflector for a phase change material in an amorphous state, in accordance with an exemplary embodiment of the present disclosure.

FIG. 19A provides a simulated 2D map for angular and spectral responses of an example meta-deflector for a phase change material in crystalline state, in accordance with an exemplary embodiment of the present disclosure.

FIG. 19B provides a measured normalized far-field radiation measured from a CCD camera for three different incident wavelengths covering the C-band of an example meta-deflector for a phase change material in crystalline state, in accordance with an exemplary embodiment of the present disclosure.

FIG. 20A provides a 2D manifold of reflection responses with an example phase change material in three crystallization levels (amorphous, L^{0%}, intermediate, L^{40%}, and crystalline, L^{100%}), in accordance with an exemplary embodiment of the present disclosure.

FIG. 20B provides a 3D manifold of reflection responses with an example phase change material in three crystallization levels (amorphous, L^{0%}, intermediate, L^{40%}, and crystalline, L^{100%}), in accordance with an exemplary embodiment of the present disclosure.

FIG. 21A provides an SEM image of an example tunable meta-switch with structural parameters including a period of 650 nm, radii of 280 nm, height of plasmonic material of 100 nm, height of first and second protective material of 5 nm, height of phase change material of 70 nm, height of dielectric nanodisks of 100 nm, and height of third protective material of 90 nm, in accordance with an exemplary embodiment of the present disclosure.

FIG. 21B provides measured reflection spectra of an example tunable meta—in three crystallization levels (amorphous, L^{0%}, intermediate, L^{40%}, and crystalline, L^{100%}) with structural parameters including a period of 650 nm, radii of 280 nm, height of plasmonic material of 100 nm, height of first and second protective material of 5 nm, height of phase change material of 70 nm, height of dielectric nanodisks of 100 nm, and height of third protective material of 90 nm, in accordance with an exemplary embodiment of the present disclosure.

FIG. 22A provides an SEM image of an example tunable meta-switch with structural parameters including a period of 550 nm, radii of 180 nm, height of plasmonic material of 100 nm, height of first and second protective material of 5 nm, height of phase change material of 70 nm, height of dielectric nanodisks of 100 nm, and height of third protective material of 90 nm, in accordance with an exemplary embodiment of the present disclosure.

FIG. 22B provides measured reflection spectra of an example tunable meta—in three crystallization levels (amorphous, L^{0%}, intermediate, L^{40%}, and crystalline, L^{100%}) with structural parameters including a period of 550 nm, radii of 180 nm, height of plasmonic material of 100 nm, height of first and second protective material of 5 nm, height of phase change material of 70 nm, height of dielectric nanodisks of 100 nm, and height of third protective material of 90 nm, in accordance with an exemplary embodiment of the present disclosure.

FIG. 23A provides an SEM image of an example tunable meta-switch with structural parameters including a period of 550 nm, radii of 160 nm, height of plasmonic material of 100 nm, height of first and second protective material of 5 nm, height of phase change material of 70 nm, height of dielectric nanodisks of 100 nm, and height of third protective material of 90 nm, in accordance with an exemplary embodiment of the present disclosure.

FIG. 23B provides measured reflection spectra of an example tunable meta—in three crystallization levels (amorphous, L^{0%}, intermediate, L^{40%}, and crystalline, L^{100%}) with structural parameters including a period of 550 nm, radii of 160 nm, height of plasmonic material of 100 nm, height of first and second protective material of 5 nm, height of phase change material of 70 nm, height of dielectric nanodisks of 100 nm, and height of third protective material of 90 nm, in accordance with an exemplary embodiment of the present disclosure.

FIG. 24A provides an SEM image of an example tunable meta-switch with structural parameters including a period of 550 nm, radii of 200 nm, height of plasmonic material of 100 nm, height of first and second protective material of 5 nm, height of phase change material of 70 nm, height of dielectric nanodisks of 100 nm, and height of third protective material of 90 nm, in accordance with an exemplary embodiment of the present disclosure.

FIG. 24B provides measured reflection spectra of an example tunable meta—in three crystallization levels (amorphous, L^{0%}, intermediate, L^{40%}, and crystalline, L^{100%}) with structural parameters including a period of 550 nm, radii of 200 nm, height of plasmonic material of 100 nm, height of first and second protective material of 5 nm, height of phase change material of 70 nm, height of dielectric nanodisks of 100 nm, and height of third protective material of 90 nm, in accordance with an exemplary embodiment of the present disclosure.

FIG. 25A presents a 3D sketch of the finite integral technique model used in the CST environment, which shows the boundary conditions, material distribution, system coordinates, and the excitation and reflection directions, perfectly match layer (PML) in the normal direction and periodic boundary condition (PBC) in the lateral direction, in accordance with an exemplary embodiment of the present disclosure.

FIG. 25B presents a schematic of the fabrication steps for an example stacked phase-change hybrid metal-dielectric metasurface.

FIGS. 26A through 26C show AFM images of surface characteristics of an example phase change material in an amorphous state (FIG. 26A) and crystalline state (FIG. 26B), in accordance with an exemplary embodiment of the present disclosure.

FIGS. 27A through 27C show binding energies of core electrons in an example phase change material, in accordance with an exemplary embodiment of the present disclosure.

FIG. 28A presents a Raman spectra for an as-deposited, crystalline, and re-amorphized phase change material, in accordance with an exemplary embodiment of the present disclosure.

FIG. 28B presents an XRD spectra for an amorphous and crystalline phase change material, in accordance with an exemplary embodiment of the present disclosure.

FIG. 29 presents 2D reflection color maps as a function of incident wavelength and varying parameters of height of dielectric (h_{Si}), height of phase change material (h_{GST}), height of third protective layer (h_{HSQ}), height of first and second protective layer (h_{SiO2}), radii of dielectric pillars (r), and period of dielectric pillars (p) for amorphous and crystalline phase change materials, in accordance with an exemplary embodiment of the present disclosure.

FIGS. 30A and 30B present a schematic of an example phase change material hybrid meta-atom under illumination with a transversed magnetic polarized light (FIG. 30A) and a transversed electric-polarized light (FIG. 30B), in accordance with an exemplary embodiment of the present disclosure.

FIGS. 31A through 31D present angular reflection colormaps for a phase change material in an amorphous state (FIGS. 31A and 31B) associated with fundamental SPP and electric dipolar modes and a phase change material in a crystalline state (FIGS. 31C and 31D) associated with MD and SPP modes under illumination with a transversed magnetic polarized light (FIGS. 31A and 31C) and a transversed electric-polarized light (FIGS. 31B and 31D), in accordance with an exemplary embodiment of the present disclosure.

FIG. 32 presents an example method of fabricating a hybrid meta-atom with phase change material, in accordance with an exemplary embodiment of the present disclosure.

FIG. 33A provides an example of a hybrid PCM metal-dielectric metasurface driven by in situ electrical pulses, in accordance with an exemplary embodiment of the present disclosure.

FIG. 33B provides an example of a hybrid PCM metal-dielectric metasurface driven by in situ electrical pulses, in accordance with an exemplary embodiment of the present disclosure.

FIGS. 34A and 34B provide real-time voltage of the applied “set” and “reset” electrical pulses (solid lines) and the corresponding temperature responses (dashed lines) in the center of the GST film for full crystallization (FIG. 34A) and amorphization processes (FIG. 34B). Inset: simulated temperature distributions at the cross section of the phase-change metasurface at the time marked by the color-coded markers, in accordance with an exemplary embodiment of the present disclosure.

FIGS. 35A through 35C provide the electric and magnetic field vector distributions for short-range SPP (SR-SPP) (FIG. 35A), the hybrid mode (FIG. 35B), and long-range SPP (LR-SPP) (FIG. 35C) within an example meta-atom, in accordance with an exemplary embodiment of the present disclosure.

FIG. 36A provides an example binary operation of the meta-switch with statistical distribution of change in measured reflectance over 50 consecutive cycles of crystallization and amorphization for 15 equal-distant wavelengths, in accordance with an exemplary embodiment of the present disclosure.

FIG. 36B provides a cyclability plot of the optical reflectance of an example meta-switch during multiple electrical set (bottom dots leading to the crystalline state) and reset (top dots leading to the amorphous state) pulses, in accordance with an exemplary embodiment of the present disclosure.

FIG. 36C provides a plot of crystallization fraction (%) versus applied pulse voltage (V) for an example meta-switch and a correlation of the modulation depth (MD), in accordance with an exemplary embodiment of the present disclosure.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

It must be noted that, as used in the specification and the appended claims, the singular forms “a,” “an” and “the” include plural referents unless the context clearly dictates otherwise. By “comprising” or “containing” or “including” it is meant that at least the named compound, element, particle, or method step is present in the composition or article or method, but does not exclude the presence of other compounds, materials, particles, method steps, even if the other such compounds, material, particles, method steps have the same function as what is named.

As used herein, the terms “about” or “approximately” for any numerical values or ranges indicate a suitable tolerance. More specifically, “about” or “approximately” can refer to the range of values ±20% of the recited value, e.g. “about 90%” can refer to the range of values from 71% to 99%.

The metasurface system architecture described herein provides an example platform for practical applications through fundamental mode engineering and subwavelength reconfiguration with an unexpected dynamic range. The systems described herein can be implemented for a variety of device/system-design architectures.

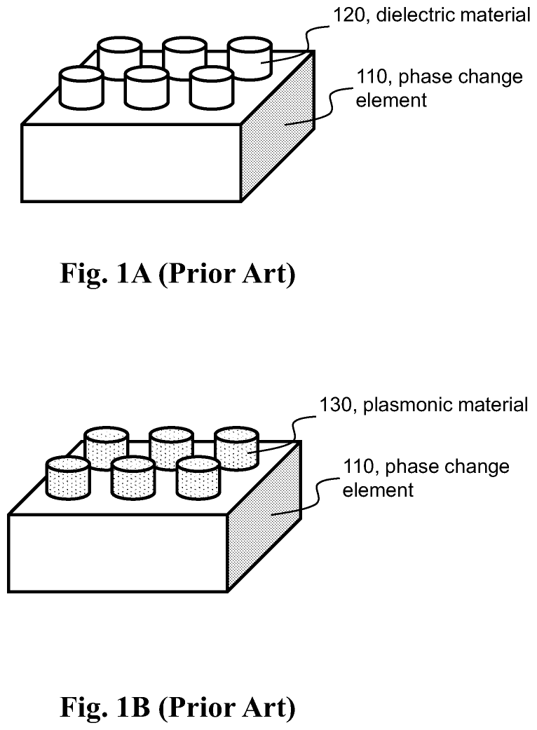

Conventional dielectric systems or plasmonic systems incorporating phase change materials are shown in FIGS. 1A and 1B, respectively. As described above, such systems suffer from optical loss, low quality factor, and low performance.

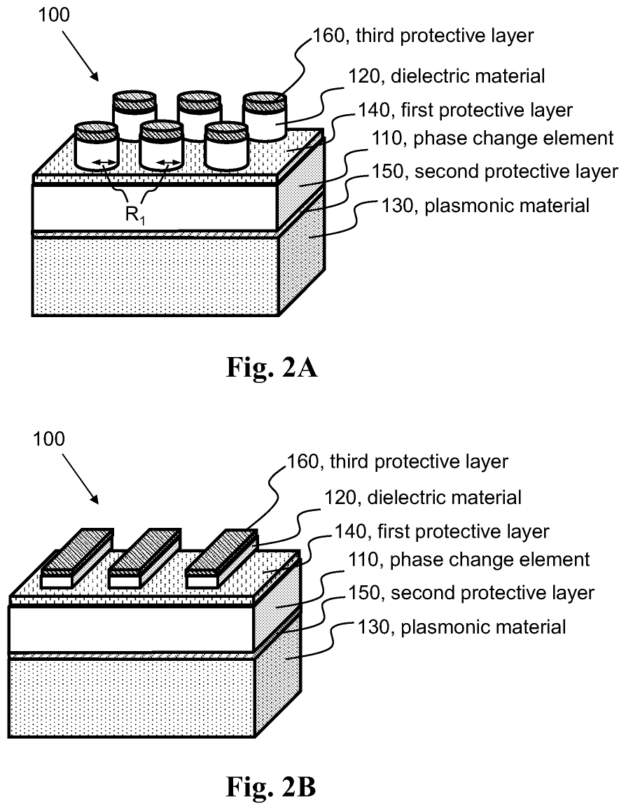

As shown in FIG. 2A, an exemplary embodiment of the present disclosure provides a hybrid metal-dielectric system 100 incorporating phase change materials 110. As shown, system 100 can include a phase change material 110 abutting a dielectric material 120 on a first surface and a plasmonic material 130 on an opposing second surface of phase change material 110. In some embodiments, the components in system 100 can be stacked as shown in FIG. 2A, where the phase change material 110 can interface with the dielectric material 120 on one surface and the plasmonic material 130 on an opposed second surface. In some embodiments, the components in system 100 can be unstacked but arranged in a suitable configuration, such as on a side or along a horizontal plane, in a series, in parallel, or perpendicular, such that the phase change material 110 can interface with both the dielectric material 120 and the plasmonic material 130. Additionally, system 100 can be arranged in the same order as shown in FIG. 2A, where the plasmonic material 130 is positioned on a bottom layer below phase change material 110 and phase change material 110 can interface with dielectric material 120. As would be appreciated, a system combining metal-dielectrics and phase change materials can be arranged and stacked in a variety of architectures having different properties. For instance, dielectric material 120 can be sandwiched between plasmonic material 130 and phase change material 110.

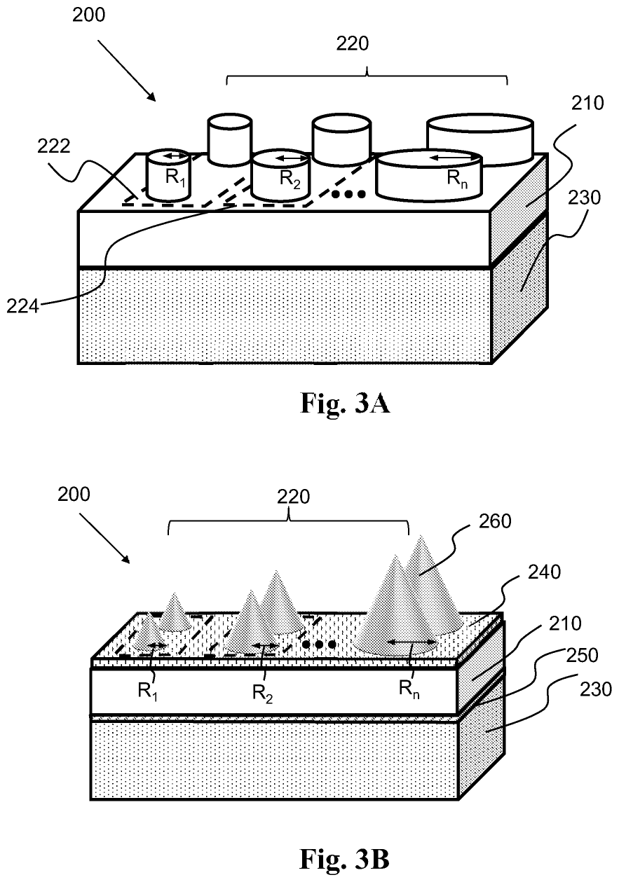

Similarly, as shown in FIGS. 3A and 3B, system 200 can be arranged in a similar architecture, where a metallic substrate 230 is positioned on a bottom layer interfacing with a phase change material layer 210 on a first surface. Phase change material layer 210 can also interface with an array of structure 220 on a second surface.

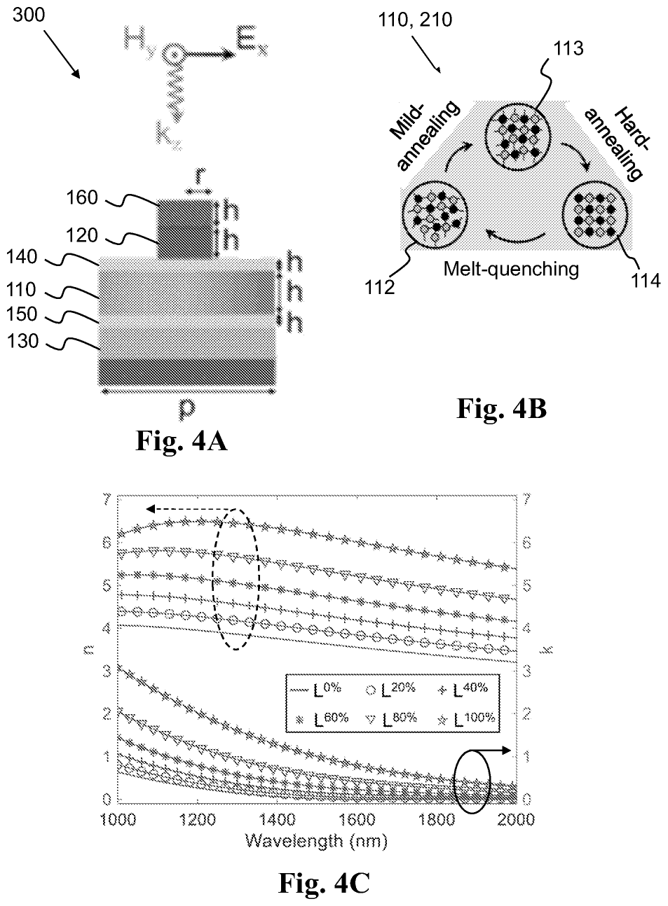

In some embodiments, system 100 can modify amplitude of a beam of electromagnetic radiation, or light, of certain wavelength ranges when such radiation travels in a path normal, or perpendicular to system 100 surface, as shown as “k_{z}” in FIG. 4A. Light with different incidence angle can also impinge system 100. In general, system 100 can modulate the beam of electromagnetic radiation, or light, in amplitude, which can also change the intensity, phase, frequency, or polarization of the radiated oscillations. Additionally, FIG. 4B depicts an example phase change material 110 transitioning from the amorphous state 112 to the crystalline state 114, with any number of intermediate states 113 not shown. By transforming phase change material 110 from a first state 112 to a second state 114, the refractive index of the phase change material 110 can be modified, thereby modulating either or both of the amplitude of light or phase of electromagnetic radiation in the optical region.

According to some embodiments, a key enabling feature of systems 100, 200 described herein and shown in FIG. 4A is the engineering of a unit cell, or “meta-atom” 300 with a range of electromagnetic modes through interplay between surface plasmon polariton (SPP), magnetic dipole (MD), and electric dipole. Integrating with phase change materials 110, 210 and utilizing the huge dynamic range of their optical properties through crystalline phase change, systems 100, 200 of this disclosure provide all major requirements for practical metasurfaces with sub-wavelength reconfigurable unit cells 300. Meta-molecules can enable a systematic design approach for forming large-scale metasurfaces for several state-of-the-art applications such as imaging, spectroscopy, data storage, light sources, microscopy, bio-photonics, subwavelength optics, computing, and quantum photonics. In some embodiments, system 100 can provide an all-optical switching, or “meta-switch.” Such a meta-switch can provide a means for increased bit rates and low latency movement of data, compared to optical-electrical conversions. For instance, a meta-switch can allow for greater routing agility, reduced energy requirements, and simplified networking structures.

Further, systems 100, 200 can undergo a coupling of the plasmon resonance supported by plasmonic material 130, 230 and the Mie-type resonance of the dielectric material 120, 220. Such coupling can offer (i) a unique, moderate-quality factor, and hybrid plasmonic-photonic mode with pronounced field confinement at the nanoscopic size, (ii) strong and efficient light scattering with particular spatio-spectral characteristics in the far-field, and (iii) high quantum efficiency, high Purcell factor, and highly directional emission in the near-field compared to all-metal or all-dielectric approaches.

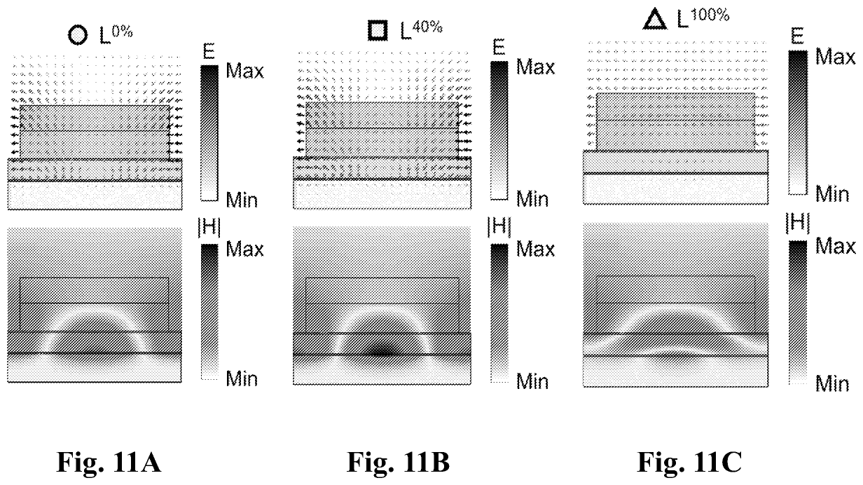

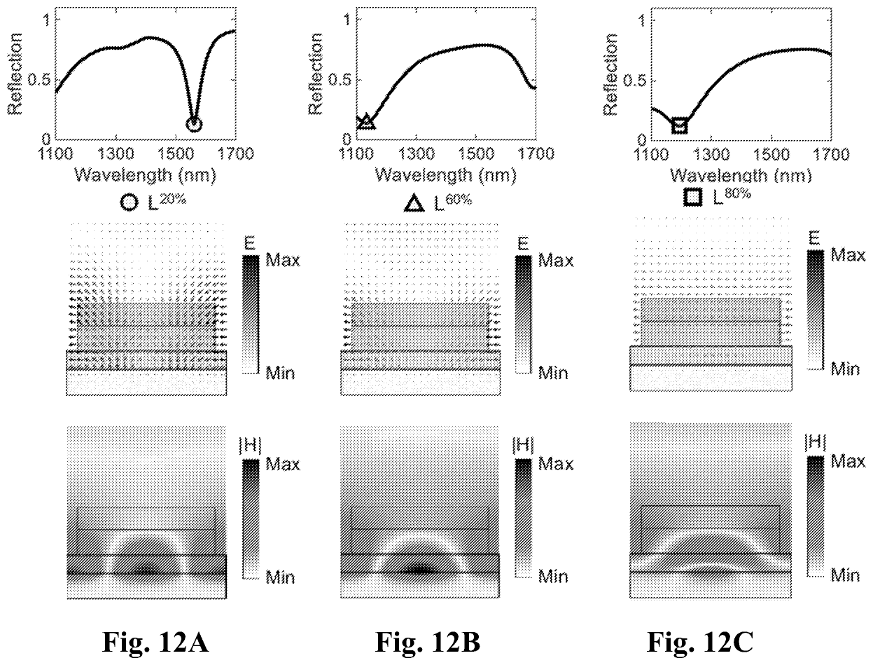

In some embodiments, system 100 can be configured to be a meta-switch, as shown in FIGS. 11A-12C for a variety of phase change material 110 crystallization states (amorphous (L^{0%}), intermediate (L^{20%}, L^{40%}, L^{60%}, L^{80%}), and crystalline (L^{100%}), 112, 113, 114). When phase change material 110 is in the amorphous state 112, system 100 can be configured to absorb a certain wavelength of light, whereas in the crystalline state 114, the system 100 can be configured to reflect the same wavelength of light. Accordingly, system 100 can transform between an absorptive modulator and a refractive modulator when phase change material 110 transitions from amorphous state 112 to crystalline state 114, respectively, upon a triggering event.

In some embodiments, system 200 can modify polarization or phase of a beam of electromagnetic radiation, or light, of certain wavelength ranges when such scattered light travels to the surface of system 200. Light with different incidence angle can interact with system 200 and experience phase shifting. In some embodiments, system 200 can tolerate a range of incidence angles ranging from about 10 degrees to about 170 degrees (e.g., from about 10 degrees to about 20 degrees, from about 20 degrees to about 30 degrees, from about 30 degrees to about 40 degrees, from about 40 degrees to about 50 degrees, from about 50 degrees to about 60 degrees, from about 60 degrees to about 70 degrees, from about 70 degrees to about 80 degrees, from about 80 degrees to about 90 degrees, from about 90 degrees to about 100 degrees, from about 100 degrees to about 110 degrees, from about 110 degrees to about 120 degrees, from about 120 degrees to about 130 degrees, from about 130 degrees to about 140 degrees, from about 140 degrees to about 150 degrees, from about 150 degrees to about 160 degrees, from about 160 degrees to about 170 degrees, from about 170 degrees to about 180 degrees, and any range within these ranges (e.g., from about 24 degrees to about 78.5 degrees)). In general, system 200 can modulate incident electromagnetic radiation, or light, in polarization or phase, which can also change the intensity, phase, frequency, or polarization of the radiated oscillations.

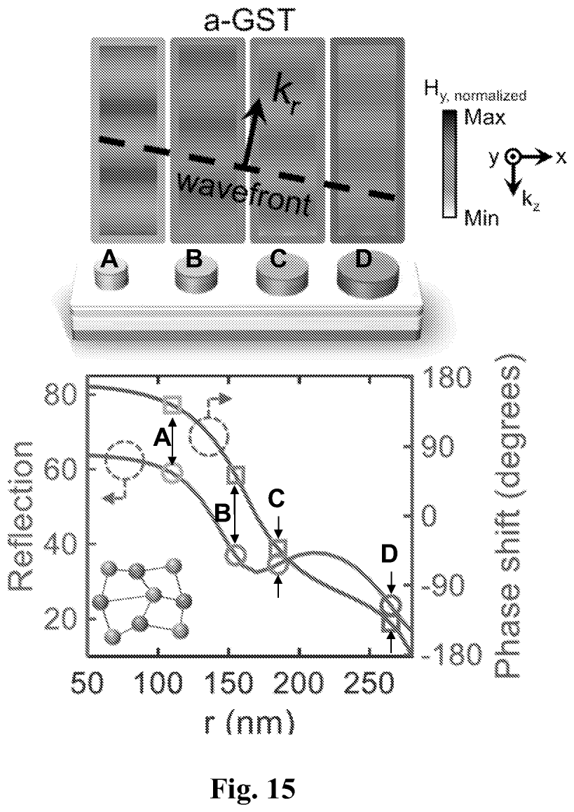

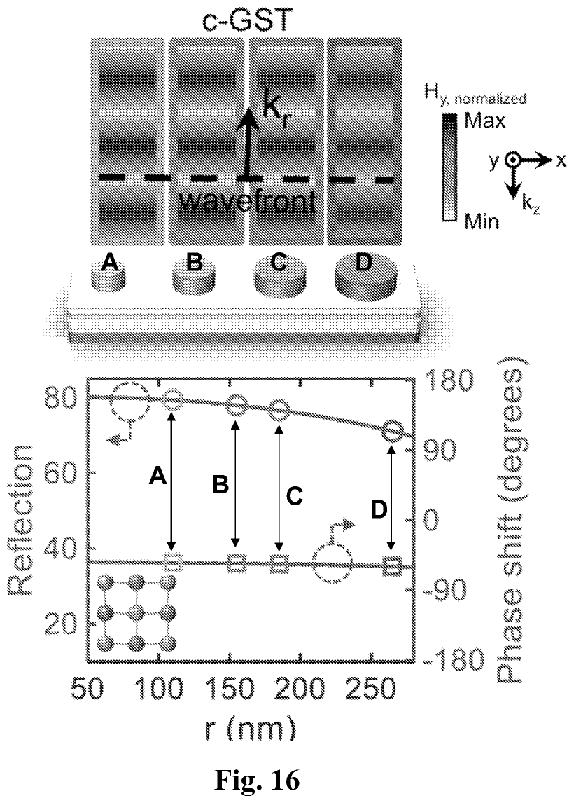

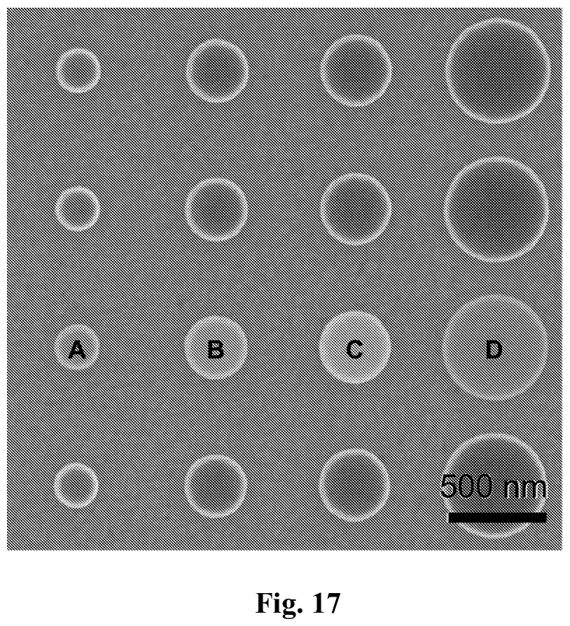

According to some embodiments, system 200 can be configured to be a meta-deflector. When phase change material 110 is in the amorphous state 112, system 200 can be configured to phase shift a certain wavelength of light, whereas in the crystalline state 114, the system 100 can be configured to maintain or prevent phase shifting the same wavelength of light, as shown in FIGS. 15 and 16. In some embodiments, system 200 having an array of structures 220 having brick or similar geometry, can transform between a quarter-wave plate and a half-wave plate when phase change material 210 transitions from amorphous state 112 to crystalline state 114, respectively, upon a triggering event.

In some embodiments a triggering event can include a thermal, electrical, or optical stimulus. In some examples, mechanical, chemical, or electromechanical stimuli can also be used to transition phase change material 110, 210 from the amorphous state 112 to the crystalline state 114, or to any intermediate state 113. Additionally, or alternatively, the triggering event can include any form of heat, current, voltage, or electromagnetic field directed to the system. Such stimuli can be achieved through hot plates, electric resistance heat, microheaters, infrared light, visible light, or any suitable means to deliver energy to systems 100, 200.

In some embodiments, the height of systems 100, 200 can be modulated by varying the height of each component. As would be appreciated, adjusting the height or geometrical parameters of any component or layer may change the optical properties of system 100 by varying the refractive indices of each individual component. Additionally, each component or layer can be deposited or grown using physical or chemical deposition as well as any other suitable technique, including, without limitation, vacuum thermal evaporation, electron beam evaporation, laser beam evaporation, arc evaporation, molecular beam epitaxy, ion plating evaporation, direct current (DC) sputtering, radio frequency (RF) sputtering, sol-gel deposition, chemical bath deposition, spray pyrolysis deposition, electroplating, electroless deposition, chemical vapor deposition (CVD), low pressure CVD, plasma enhanced CVD, atomic layer deposition (ALD), and the like. Accordingly, the thickness of any component or layer may vary depending on the technique and composition of material used.

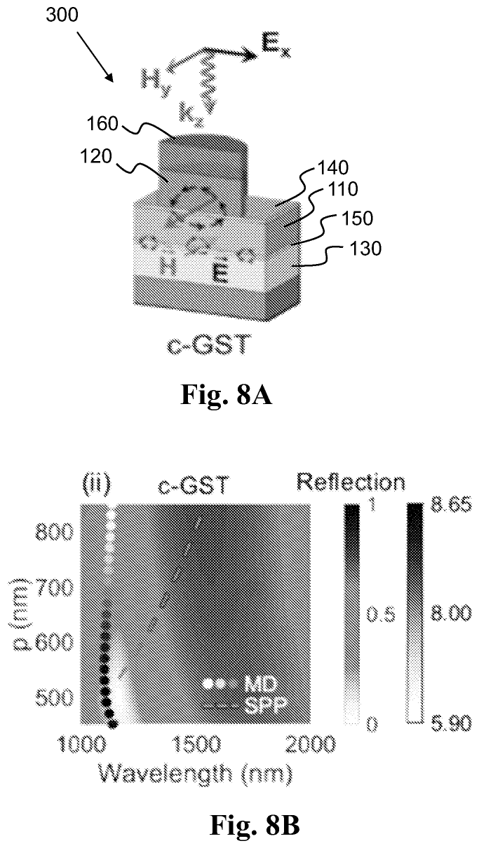

In general, phase change materials can absorb or release large amounts of heat when they go through a change in their physical state (e.g., from solid to liquid, from cross-linked to uncross-linked, or from amorphous to crystalline). As would be appreciated by those of skill in the art, a solid-solid phase change material is ideal for systems 100, 200 for modulation of electromagnetic radiation, for their inherent advantages over solid-liquid counterparts (e.g., no leakage, no need to encapsulation, less volume variation, etc.). In some embodiments, phase change material 110, 210 can include a combination of two or more materials from the group consisting of germanium, antimony, tellurium, selenium, indium, titanium, gallium, bismuth, tin, copper, lead, palladium, silver, sulfur, vanadium, and gold. In some embodiments, alloys including germanium antimony telluride (Ge₂Sb₂Te₅, or GST), germanium antimony selenium telluride (Ge₂Sb₂Se₄Te₁, or GSST), antimony sulfide (Sb₂S₃), antimony selenide (Sb₂Se₃), antimony telluride (Sb₇Te₃), germanium telluride (GeTe), germanium selenide (GeSe₃), and vanadium oxide (VO₂) may provide varying optical properties when transitioning between the amorphous state 112 to crystalline state 114 under stimulation. For instance, GST may be configured to absorb at a wavelength range of about 1250 nm to about 1350 nm when in the crystalline state 114 (as shown in FIG. 8B), whereas GSST may red-shift the resonance condition to longer wavelengths in the crystalline state 114.

In some embodiments, phase change material 110, 210 may be composed of a combination of two of more polymeric solid-solid phase change materials including, without limitation, polystyrene, cellulose, poly(ethylene glycol), styrene acrylonitrile, poly(styrene-co-allyalcohol), sorbitol, dipentaerythritol, inositol, melamine, formaldehyde, polyethyl eneglycol, polyethylene oxide, carboxymethyl cellulose, polyvinyl alcohol, and poly(polyethylene glycol methyl ether methacrylate).

According to some embodiments, phase change material 110, 210 may also comprise an organometallic solid-solid phase change material. For instance, organometallics having the general chemical formula (n-CₙH₂ₙ₊₁NH₃)₂MX₄, where M is a metal atom, X is a halogen, and n is an integer from 8 to 18, can provide unique optical properties to systems 100, 200.

In some embodiments, phase change material 110 and phase change material layer 210 can include a height ranging from about 20 nm to about 200 nm (e.g., from about 20 nm to about 30 nm, from about 30 nm to about 40 nm, from about 40 nm to about 50 nm, from about 50 nm to about 60 nm, from about 60 nm to about 70 nm, from about 70 nm to about 80 nm, from about 80 nm to about 90 nm, from about 90 nm to about 100 nm, from about 100 nm to about 110 nm, from about 120 nm to about 130 nm, from about 120 nm to about 130 nm, from about 130 nm to about 140 nm, from about 140 nm to about 150 nm, from about 150 nm to about 160 nm, from about 160 nm to about 170 nm, from about 170 nm to about 180 nm, from about 180 nm to about 190 nm, from about 190 nm to about 200 nm, and any range within these ranges (e.g., from about 56.8 nm to about 77.1 nm)). As would be appreciated, the thickness or height of phase change material 110, 210 can alter the refractive index of systems 100, 200.

In general, dielectric material can be polarized by an applied electric or magnetic field. In some embodiments, dielectric material 120, 220 can be silicon, silicon carbide, silicon nitride, aluminum nitride, germanium, alumina, gallium nitride, hafnium oxide, zirconium oxide, titanium dioxide, indium tin oxide, lithium niobate, silicon dioxide, gallium phosphate, gallium arsenide, hafnium silicate, zirconium silicate, strontium titanate, barium titanate, barium strontium titanate, calcium copper titanate, silsesquioxane, hydrogen silsesquioxane, polyethylene, polypropylene, polystyrene, and polytetrafluoroethylene.

In some embodiments, dielectric material 120 and array of structures 220 can include a height ranging from about 20 nm to about 250 nm (e.g., from about 20 nm to about 30 nm, from about 30 nm to about 40 nm, from about 40 nm to about 50 nm, from about 50 nm to about 60 nm, from about 60 nm to about 70 nm, from about 70 nm to about 80 nm, from about 80 nm to about 90 nm, from about 90 nm to about 100 nm, from about 100 nm to about 110 nm, from about 110 nm to about 120 nm, from about 120 nm to about 130 nm, from about 130 nm to about 140 nm, from about 140 nm to about 150 nm, from about 150 nm to about 160 nm, from about 160 nm to about 170 nm, from about 170 nm to about 180 nm, from about 180 nm to about 190 nm, from about 190 nm to about 200 nm, from about 200 nm to about 210 nm, from about 210 nm to about 220 nm, from about 220 nm to about 230 nm, from about 230 nm to about 240 nm, from about 240 nm to about 250 nm, and any range within these ranges (e.g., from about 156.2 nm to about 217.1 nm)).

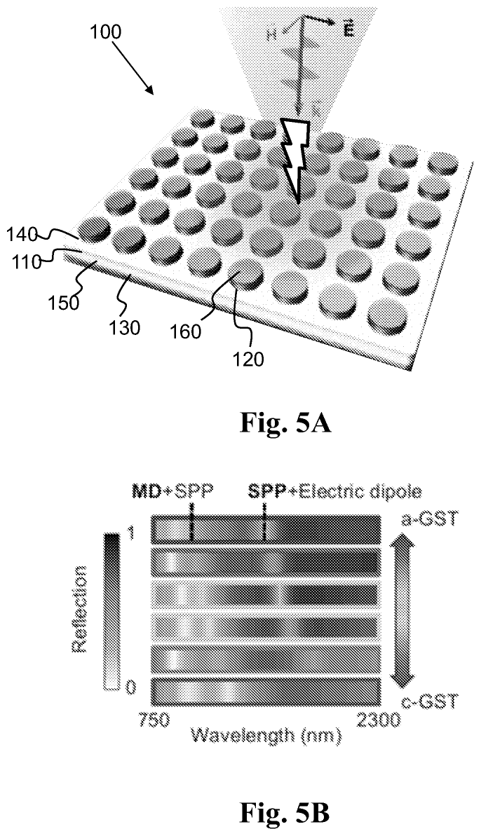

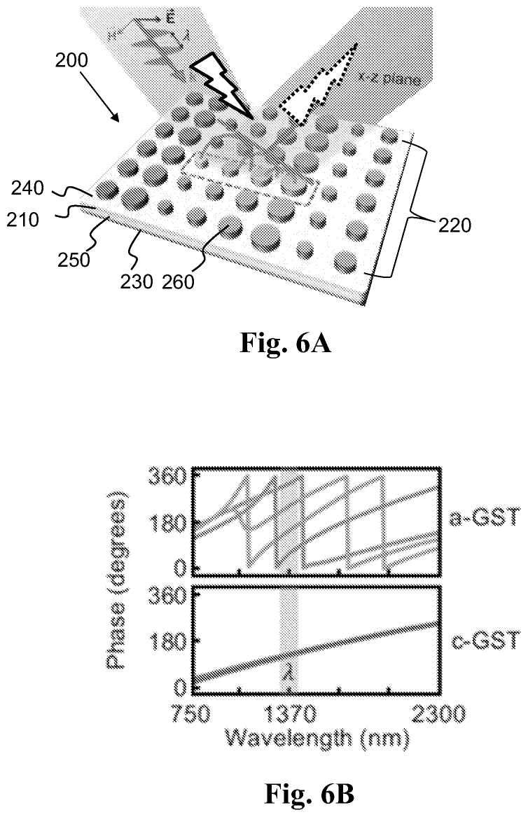

Referring back to FIGS. 2A and 2A, example systems 100, 200 can include a dielectric material 120 arranged in an array of structures 220, or nano scatterers, on the first surface of phase change material 110, 210. In some embodiments, the structures can be symmetric and have the same or similar radii among structures in adjacent rows (e.g., R₁˜R₁), as shown in FIG. 5A. Alternatively, or in addition thereto, system 200 can include an array of structures 220, as shown in FIGS. 3A and 3B, where a first row of structures 222 includes a first radius R₁ and a second row of structures 224 includes a second radius R₂. System 200 can include any number of rows of structures having varying radii Rₙ. In some embodiments, the rows may increase in radii in a continuous manner (e.g., R₁<R₂<R₃<Rₙ . . . ). In some embodiments, adjacent structures within an array of structures 220 can have varying radii in a repeating series. For instance, as shown in FIG. 6A, a series of four rows may have radii increases that repeat every four rows along an array (e.g., R₁<R₂<R₃<R₄>R₁ . . . R₄). As would be appreciated, the number of structures in a series of increasing radii can be adjusted to modulate the optical properties of system 200. For example, a series of two rows with increasing radii can be implemented (e.g., R₁<R₂>R₁<R₂, . . . ). Additionally, or alternatively, a series of arbitrary radii may be constructed. The structures of system 100, with relatively similar radii, or system 200, with radii varying among series of adjacent rows, can have radii that range from about 10 nm to about 500 nm (e.g., from about 10 nm to about 20 nm, from about 20 nm to about 30 nm, from about 30 nm to about 40 nm, from about 40 nm to about 50 nm, from about 50 nm to about 60 nm, from about 60 nm to about 70 nm, from about 70 nm to about 80 nm, from about 80 nm to about 90 nm, from about 90 nm to about 100 nm, from about 100 nm to about 150 nm, from about 150 nm to about 200 nm, from about 200 nm to about 250 nm, from about 250 nm to about 300 nm, from about 300 nm to about 350 nm, from about 350 nm to about 400 nm, from about 450 nm to about 500 nm, and any range within the range provided herein (e.g., from about 64 nm to about 441 nm)). For system 200, with radii varying among series of adjacent rows, the radii can increase arbitrarily or by a certain degree (e.g., percentage increase, double, or the like). As would be appreciated by those of skill in the art, altering radii among series of adjacent rows can provide for controlled phase shifting of incident light.

In a patterned array of structures 220, the length from one center of a structure to the center of an adjacent structure defines the period of the array. According to some embodiments, the dielectric material structures 120, 220 in systems 100, 200 can range from about 50 nm to about 1000 nm (e.g., from about 50 nm to about 60 nm, from about 60 nm to about 70 nm, from about 70 nm to about 80 nm, from about 80 nm to about 90 nm, from about 100 nm to about 150 nm, from about 150 nm to about 200 nm, from about 200 nm to about 250 nm, from about 250 nm to about 300 nm, from about 300 nm to about 350 nm, from about 350 nm to about 400 nm, from about 400 nm to about 450 nm, from about 450 nm to about 500 nm, from about 500 nm to about 550 nm, from about 550 nm to about 600 nm, from about 600 nm to about 650 nm, from about 650 nm to about 700 nm, from about 700 nm to about 750 nm, from about 750 nm to about 800 nm, from about 800 nm to about 850 nm, from about 850 nm to about 900 nm, from about 900 nm to about 950 nm, from about 950 nm to about 1000 nm, and any range within the range provided herein (e.g., from about 642 nm to about 921 nm)). In general, the radii should be less than half of the period in the dielectric material 120 or array of structures 220.

In addition, the structures can form any suitable geometric shape for optimizing the optical properties of system 100, 200, for example, the structures can be cylindrical, as depicted in FIG. 2A, rectangular or cuboid (FIG. 2B), conical (FIG. 3B). Although not depicted, it is contemplated that the dielectric material structures 120, 220 can also be truncated cones, tetrahedrons, spheres, octahedrons, square pyramids, pentagonal prisms, hemispheres, hexagonal pyramids, dodecahedrons, triangular prisms, bars, V-shaped, and the like. In addition, the structures can be rotated around a perpendicular axis on the surface of phase change material 110, 210.

In general, a plasmonic material is a material that exploits surface plasmon resonance effects to achieve optical properties. In some embodiments, plasmonic material 130 can be a metal such as gold, silver, aluminum, bismuth, copper, palladium, titanium, and tungsten. In some embodiments, plasmonic material 130 can be compounds including metal-like materials such as titanium nitride, indium phosphide, aluminum-zinc-oxide, gallium-zinc-oxide, indium-tin-oxide, and indium nitride.

In some embodiments, plasmonic material 130 and metal substrate 230 can include a height ranging from about 20 nm to about 200 nm (e.g., from about 20 nm to about 30 nm, from about 30 nm to about 40 nm, from about 40 nm to about 50 nm, from about 50 nm to about 60 nm, from about 60 nm to about 70 nm, from about 70 nm to about 80 nm, from about 80 nm to about 90 nm, from about 90 nm to about 100 nm, from about 100 nm to about 110 nm, from about 120 nm to about 130 nm, from about 120 nm to about 130 nm, from about 130 nm to about 140 nm, from about 140 nm to about 150 nm, from about 150 nm to about 160 nm, from about 160 nm to about 170 nm, from about 170 nm to about 180 nm, from about 180 nm to about 190 nm, from about 190 nm to about 200 nm, and any range within these ranges (e.g., from about 26.8 nm to about 77.1 nm)).

In some embodiments, system 100, 200 can include a first protective layer 140, 240 located at the first surface of phase change material 110 or phase change material layer 210, along the interface of phase change material 110, 210 and dielectric material 120 and array of structures 220. Alternatively, or in addition thereto, system 100, 200 can further include a second protective layer 150, 250 located at the second surface of phase change material 110 or phase change material layer 210, along the interface of phase change material 110, 210 and plasmonic material 130 or metal substrate 230. In some embodiments, the first and second protective layers 140, 240, 150, 250 can have the same height or thickness. Alternatively, first protective layer 140, 240 can have a height or thickness that is different than second protective layer 150, 250. The first and second protective layers 140, 240, 150, 250 can be deposited or grown on the surface of phase change material layer 110, 210 or the surface of plasmonic material 130, 230, respectively, using physical or chemical deposition or other suitable technique as described above. Accordingly, the thickness of first protective layer 140, 240 and second protective layer 150, 250 may vary depending on the technique used. For instance, using ALD, Angstrom-sized thicknesses can be achieved and built upon to reach greater thicknesses. In some embodiments, the thickness of first protective layer 140, 240 and second protective layer 150, 250 can each independently range from about 0.5 nm to about 50 nm (e.g., from about 0.5 nm to about 1.5 nm, from about 1 nm to about 2 nm, from about 1.5 nm to about 2.5 nm, from about 2 nm to about 3 nm, from about 2.5 nm to about 3.5 nm, from about 3 nm to about 4 nm, from about 3.5 nm to about 4.5 nm, from about 4 nm to about 5 nm, from about 4.5 nm to about 5.5 nm, from about 4 nm to about 5 nm, from about 5.5 nm to about 6.5 nm, from about 5 nm to about 6 nm, from about 6.5 nm to about 7.5 nm, from about 6 nm to about 7 nm, from about 7.5 nm to about 8.5 nm, from about 7 nm to about 8 nm, from about 8.5 nm to about 9.5 nm, from about 8 nm to about 9 nm, from about 9.5 nm to about 12.5 nm, from about 10 nm to about 15 nm, from about 12.5 nm to about 17.5 nm, from about 15 nm to about 20 nm, from about 20 nm to about 25 nm, from about 25 nm to about 30 nm, from about 30 nm to about 35 nm, from about 35 nm to about 40 nm, from about 40 nm to about 45 nm, from about 45 nm to about 50 nm, and any range within these ranges (e.g., from about 6.8 nm to about 11.3 nm)).

In general, thin layers of materials having low-index or low absorption properties can act as protective layers. In some embodiments, the first and second protective layers 140, 240, 150, 250 can include materials suitable for coatings, including, without limitation, silicon dioxide, titanium dioxide, hafnium oxide, zirconium oxide, alumina, aluminum oxide, iron oxide, magnesium oxide, calcium oxide, calcium sulfate, niobium silicide, molybdenum silicide, silicone polymers, and the like.

In some embodiments, system 100, 200 can also include a third protective layer 160, 260 bordering the dielectric material 120 or array of structures 220 on an external surface opposite the phase change material 110, 210. In some embodiments, the third protective layer 160, 260 can have the same height or thickness as the first and second protective layers 140, 240, 150, 250. Alternatively, third protective layer 160, 260 can have a height or thickness that is different than first or second protective layer 140, 240, 150, 250. Similar to other components, third protective layer 160, 260 can be deposited or grown on the surface of dielectric material 120 or array of pillars 220 using physical or chemical deposition or other suitable technique as described above. Accordingly, the thickness of third protective layer 160, 260 may vary depending on the technique used. In some embodiments, the thickness of third protective layer 160, 260 can range from about 30 nm to about 150 nm (e.g., from about 30 nm to about 40 nm, from about 40 nm to about 50 nm, from about 50 nm to about 60 nm, from about 60 nm to about 70 nm, from about 70 nm to about 80 nm, from about 80 nm to about 90 nm, from about 90 nm to about 100 nm, from about 100 nm to about 110 nm, from about 120 nm to about 130 nm, from about 120 nm to about 130 nm, from about 130 nm to about 140 nm, from about 140 nm to about 150 nm, and any range within these ranges (e.g., from about 56.8 nm to about 77.1 nm)).

In general, thin layers of coating materials having dielectric properties can be beneficial protective layers over dielectric material 120, 220. In some embodiments, third protective layer 160, 260 can include materials suitable for coatings similar to first and second protective layer 140, 240, 150, 250, and can also include, without limitation, silsesquioxane, hydrogen silsesquioxane, octadimethylsiloxysilsesquioxane, poly(methylsilsesquioxan), poly(hydridosilsesquioxane), polyethylene, polypropylene, polystyrene, and polytetrafluoroethylene, and the like.

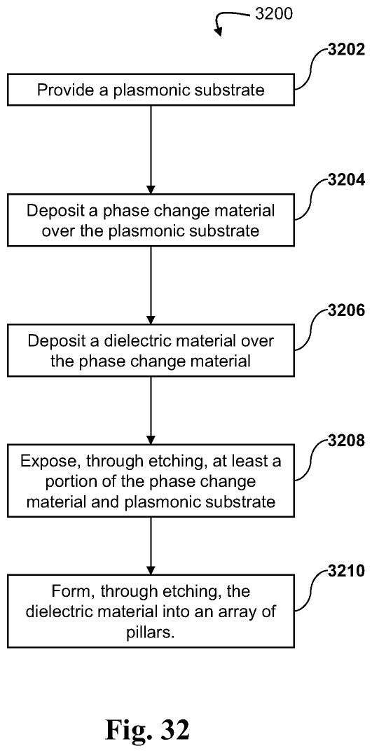

FIG. 32 illustrates an example method 3200 for of fabricating a hybrid meta-atom with phase change material. The method can include at step 3202 providing a plasmonic substrate. At step 3204, the method can further include depositing a phase change material over the plasmonic substrate. At step 3206, the method can include depositing a dielectric material over the phase change material. At step 3208, the method can include exposing, through etching, at least a portion of the phase change material and plasmonic substrate, such that, at step 3210, the method can further form, through etching, the dielectric material into an array of pillars.

In some embodiments, when forming the dielectric material into an array of pillars, the method 3200 can further include forming a symmetric array with pillars having identical or similar radii. In a system having an array of similarly sized pillars, the method can further include transmitting a wavelength of light in a path normal to the array of pillars and receiving a first optical response when the wavelength of light is absorbed by the system when the phase change material is in an amorphous state. For example, when the phase change material is in the amorphous state, the system may act as an absorptive modulator.

In some embodiments, the method 3200 can further include stimulating the system to transform the phase change material from the amorphous state to a crystalline state. When the phase change material is in the crystalline state, the method can further include transmitting the wavelength of light in a path normal to the array of pillars and receiving a second optical response when the wavelength of light is reflected by the system. For instance, in this instance when the phase change material is in the crystalline state, the system may act as a refractive modulator.

In some embodiments, when forming the dielectric material into an array of pillars, the method 3200 can further include forming an asymmetric array, where a first pillar has a radius different than an adjacent pillar. In a system having an array of increasing radius-sized pillars in a series, the method can further include stimulating the system to transform a phase change material from an amorphous state to a crystalline state. The method can further include transmitting a wavelength of incident light to the array of pillars and receiving a third optical response when the phase of the wavelength of incident light is shifted by the system when the phase change material is in the amorphous state.

The following examples further illustrate aspects of the present disclosure. However, they are in no way a limitation of the teachings or disclosure of the present disclosure as set forth herein.

### EXAMPLES

The unique features of phase change materials were used to demonstrate the active control of the scattering properties of a hybrid metal-dielectric metasurface. An architecture for reconfigurable metasurfaces was experimentally demonstrated with non-volatile engineering of the characteristic resonances of supported magnetic Mie mode (or magnetic dipole (MD)) and electric dipole mode supported by the engineered dielectric meta-atoms and the surface plasmon polariton (SPP) mode supported by a plasmonic back reflector. Full-wave simulation results reveal that the enhancement of light-matter interaction within the tunable functional GST layer can be controlled on-demand resulting in the generation/cancellation and strengthening/weakening of such particular modes at specific wavelengths. Besides the wealthy physics governing the operation of associated reconfigurable hybrid metasurfaces, the incorporation of plain plasmonic metal substrate can facilitate the reversible phase switching of the GST material via the Joule heating process. This is in contrary to most of previous demonstrations in which the PCM is incorporated into the plasmonic meta-atoms (with a melting temperature comparable to that needed to excite the phase-change process of the PCM) that are vulnerable to deformation in the melt-quenching process needed for the re-amorphization of PCMs. As a proof-of-concept, two classes of dynamic meta-devices were demonstrated: i) a polarization-insensitive absorptive metasurface (or a meta-switch) exhibiting high absorption performance with a characteristic modulation depth comparable to the state-of-the-art alternative devices, and ii) a beam-steering metasurface (or a meta-deflector) for deflecting a monochromatic light beam to the anomalous/specular angle upon the active transition of the GST state using thermal processes. The experimental results described herein suggest the potential of the demonstrated hybrid architecture for realization of a wide range of multifunctional meta-devices including thermal imagers and optical beam formers with unique features for applications like imaging, sensing, computing, and ranging.

The results were achieved by using a blanket of PCM layer for the entire metasurface. The next step is to fabricate structures with 2D PCM patches that can be independently controlled. It is also essential to use electrical PCM phase control by using proper wiring using ITO. Fortunately, there is a lot of knowledge from the field of data storage in independent addressing of miniaturized GST regions, which could be adopted for reconfigurable metasurfaces. This will be a major advantage over alternative architectures that have major challenges to address 2D pixels with good dynamic range and spatial resolution. Finally, the platform discussed here has superior performance in terms of speed and power consumption. PCMs like GST can operate with 10's-100's ns reconfiguration time. Their non-volatile phase-change mechanism also remove any DC power consumption, and all power consumption is due to the signals during the phase-change process. As an example, energies in the order of 19.2 aJ/nm³ (6.6 aJ/nm³) for crystallization (amorphization) of GST with have been reported recently.

Being a mature phase-change material (PCM), the germanium antimony telluride alloy (Ge₂Sb₂Te₅ or GST for short) has been vastly exploited in the commercial rewritable optical disk storage and resistive-switching electronic memory technologies. Such technological interests stem from intrinsic features including ultra-fast switching speed (nanosecond or less), considerable spatial control and miniaturization (down to nm sizes), high switching robustness (up to 1015 cycles), good thermal stability (up to several hundred degrees Celsius), and compatibility with the CMOS fabrication technology. Notably, the non-volatile nature of optical/electrical changes in GST makes it superior in terms of static energy consumption. Moreover, the intermediate phase transition of GST (between amorphous and fully crystalline phases), empowers meta-atoms to induce arbitrary changes to amplitude and phase responses of incident light, leading to reprogrammable pixellated multifunctional metasurfaces.

### Example 1—Metasurface Working Principle

Schematic representations of the proposed tunable GST-assisted hybrid metal-dielectric meta-atom is shown in FIG. 4A. It consists of a Si nanodisk sitting on top of a GST layer deposited on an optically-opaque gold (Au) back reflector. In the near-IR regime, GST essentially serves as a functional dielectric medium whose optical properties can be finely tuned by applying an external stimulus. This leads to distinct non-volatile intermediate states enabling step-wise manipulation of the optical wavefront even at a pixel level. Complex refractive index of GST in the two extreme states, i.e., amorphous (a-GST associated with 0% crystallization level, i.e., L^{0%}) and crystalline (c-GST associated with 100% crystallization level, i.e., L^{100%}), and 4 intermediate levels are demonstrated in the FIG. 4C. The optical constants of GST in the intermediate levels are calculated using a well-known effective medium theory. Upon thermal-based con-version to c-GST on top of a hotplate, a remarkable contrast is induced in the complex index of a-GST (e.g., Δn≈2.5 and Δk=0.9 at λ=1550 nm, with n and k being the real and imaginary parts of the index of refraction) due to a pronounced change in the alloy chemical formation (from the covalent bonding in a-GST to the resonance bonding with high electronic polarizability in c-GST) as conceptually shown in FIG. 4B.

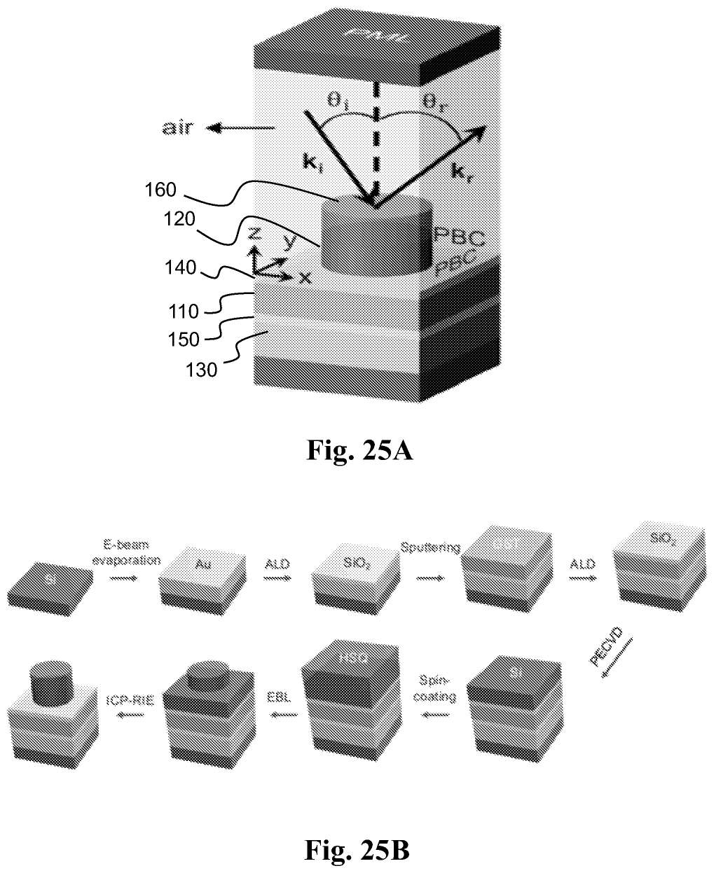

Perspective views of two classes of reprogrammable metasurfaces, i.e., a meta-switch and a meta-deflector, that employ uniform matrices of hybrid meta-atoms and meta-molecules are depicted in FIGS. 5A and 6A, respectively. Ultimate manipulation of the amplitude and phase property of reflected light from these meta-devices is enabled through gradual and abrupt transition of underlying hybrid modes thanks to the dynamically tunable GST layer (see FIGS. 5B and 6B). The representative flow diagram of the fabrication process of such meta-devices is shown in FIG. 25B, and its detailed explanation is provided in Example 6 below.

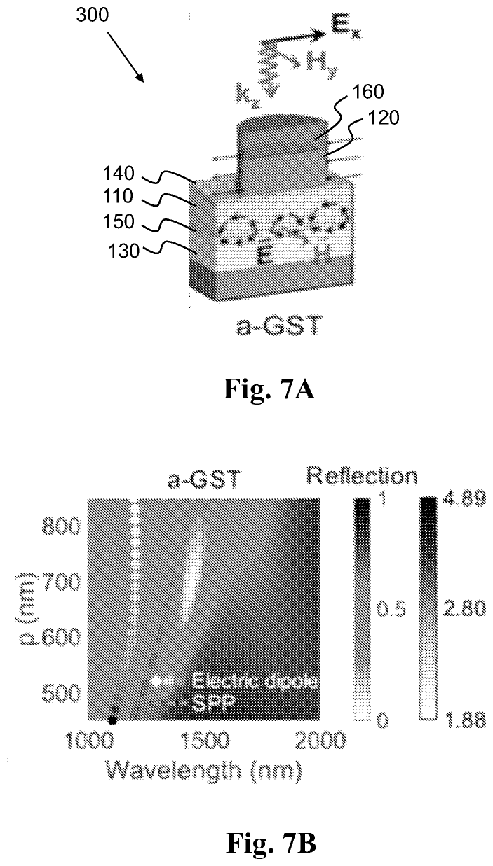

The proposed meta-atom in FIG. 7A features part-plasmonic and part-photonic modes (in both cases of a-GST and c-GST) that enable truly-subwavelength vertical confinement and horizontal enhancement of the electromagnetic field, respectively. The resonance properties of the meta-atom are dictated by the interaction of the plasmonic and photonic modes. The interference of these two modes in the meta-atom facilitates on-demand high radiation at the low-loss dielectric-air interface with more efficiency than conventional fully-plasmonic or fully-dielectric configurations. In order to reveal the underlying nature of light-matter interaction at different crystallization states of GST in the hybrid meta-atom, a full-wave numerical simulations was conducted for all relevant cases.

The calculated reflection profile for the meta-atom in FIGS. 4A and 7A as a function of wavelength (λ) for different pitch sizes (p) are shown in FIG. 7B, showing a profound reflection dip at a wavelength that varies with p. The excitation of this “hybrid” resonance mode is ascribed to the interference of the SPP mode, which is induced due to the metasurface periodicity providing an additional momentum, with the electric dipole moment, which is induced by enhanced light-matter interaction in the corners of the highly polarizable Si nanodisk (see FIG. 7A).

For a square array of meta-atoms, the momentum matching condition between the SPP and the in-plane component of the wavevector of the incident light can be described by Bragg's coupling equation:

k₀(λ)sin(θ)±iGₓ±jG_{y}=k_{SPP}(λ),

|k_{SPP}(λ)|=|k₀(λ)|n_{SPP},

wherein, λ is the incident wavelength, k₀ and θ are the wavevector and angle of incidence (see FIG. 5A), integers i and j are the grating orders for the reciprocal lattice vectors Gₓ and G_{y} (|Gₓ|=|G_{y}|=2π/p), and n_{SPP} being the effective index of the SPP mode. Considering normal illumination (i.e., 0=0), grating coupling arises when p=√(i²+j²), where λ_{SPP} is the wavelength of the SPP mode. The dashed curve in FIG. 7B illustrates the coupling of the incoming wave to the (i, j)=(1, 0) SPP. Full-wave simulation was carried out to calculate n_{SPP} of the structure shown in FIG. 5A in the absence of the nanodisk array.

The gray-scale dotted line in FIG. 7B displays the spectral evolution of the electric dipolar resonance of a 400 nm-wide nanodisk array given that in the simulation the Au substrate is replaced by a perfect electric conductor (PEC) to isolate the effect of the SPP. Since this is a non-propagating localized mode bounded to the Si nanodisk end-faces, a dispersionless behavior is expected. Having a close look, this mode experiences weak dispersion for larger fill factors (i.e., r/p) in FIG. 4A, where each individual nanodisk slightly couples to its neighbors, while this effect fairly vanishes for higher values of p (at a fixed r). The gray color bar in FIG. 7B, which represents the normalized field enhancement in the middle of two adjacent meta-atoms, well justifies this effect. In this regard, the electric dipole moment is strong enough to destructively interfere with the SPP mode and diminish the reflection dip for the lower pitch sizes (p). However, for the larger p, the overall reflection is naturally inclined to the SPP response as the dominant mode of the structure. This can be justified through Eq. 1, in which by increasing the pitch size, the reflection dip of the metasurface, due to the grating coupling of the incident light to the SPP mode, redshifts.

As shown in FIG. 8B, by transforming the a-GST to c-GST, the overall reflection response of the metasurface FIG. 5A significantly changes. The broadened feature of the resonance in this spectral window is mainly due to the intrinsic loss of the c-GST. The resonant mechanism is attributed to the excited SPP mode (represented by the blue dashed line FIG. 7B that is fairly overshadowed by the magnetic Mie resonance (represented by the gray-scale dotted line). This stems from: i) the remarkable refractive index contrast between c-GST and Si that hinders the effective diffraction of the incident light by nanodisks into the c-GST spacer, and ii) more importantly, the large complex permittivity of c-GST, as the host medium of polaritons, in direct contact with the plasmonic metal that leads to the weak excitation of SPP mode.

To justify the existence of the MD as the dominant mode of the metasurface in the crystalline state of GST, the reflection spectrum was calculated as a function of the Si nanodisk thickness while considering the Au back reflector as a PEC. Due to the high effective refractive index of c-GST, the combination of the Si nanodisk and the subjacent GST segment was treated with an effective volume comparable to that of the nanodisk as a “high-index pseudo-pillar”, which is the host of the MD. Such a strong dipole, which is oriented perpendicular to the polarization of the circulating electric field inside the pseudo-pillar, is induced by the displacement current loop governed by the electric field of incident light. The effective driving of this displacement current loop significantly depends on the retardation of the incident field along the propagation of light in the pseudo-pillar. When the effective wavelength of light inside the pseudo-pillar becomes comparable to its size, the MD is excited. As a result, h_{Si} is expected to play a key role in the MD excitation where, by increasing h_{Si}, the reflection dip and the normalized magnetic field enhancement are expected to be first improved and then dropped. Similar results are achieved by exploiting the generalized method of image applied to the multipole expansion approach to study the scattered light from the reflective hybrid meta-atom. These results imply that there exists an optimum height at which the polarization of the incident electric field becomes anti-parallel at the ends of the pseudo-pillar, and thus, the magnetic component of the incident field is highly enhanced at the center of the pseudo-pillar. Given the optimum h_{Si}, the dotted line in FIG. 8B shows that for the lower range of p values, the MD moment affords higher normalized field enhancement. Thanks to the constructive interference between the SPP and the MD in this region, the deepest reflection dip forms at p=490 nm. To get a deeper insight into the origination of fundamental modes, angle-resolved reflection calculation and parametric study was carried out.

### Example 2—Dynamic Hybrid Metasurface to Control the Amplitude Response

To show the unique capabilities of the metasurface architecture in FIGS. 2A-4A, a tunable meta-switch with high modulation depth in a wide window of the near-IR spectral range was designed and experimentally demonstrated.

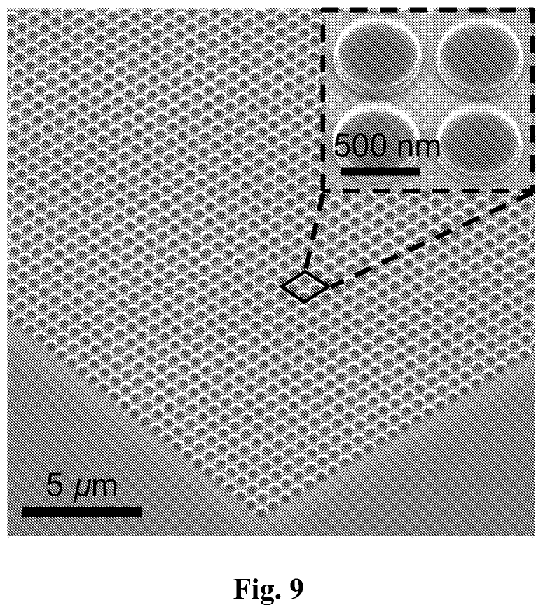

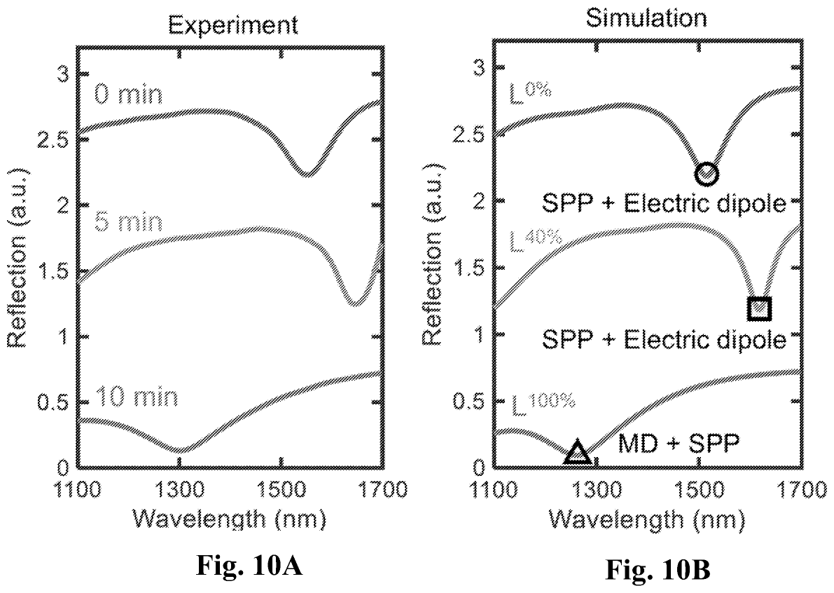

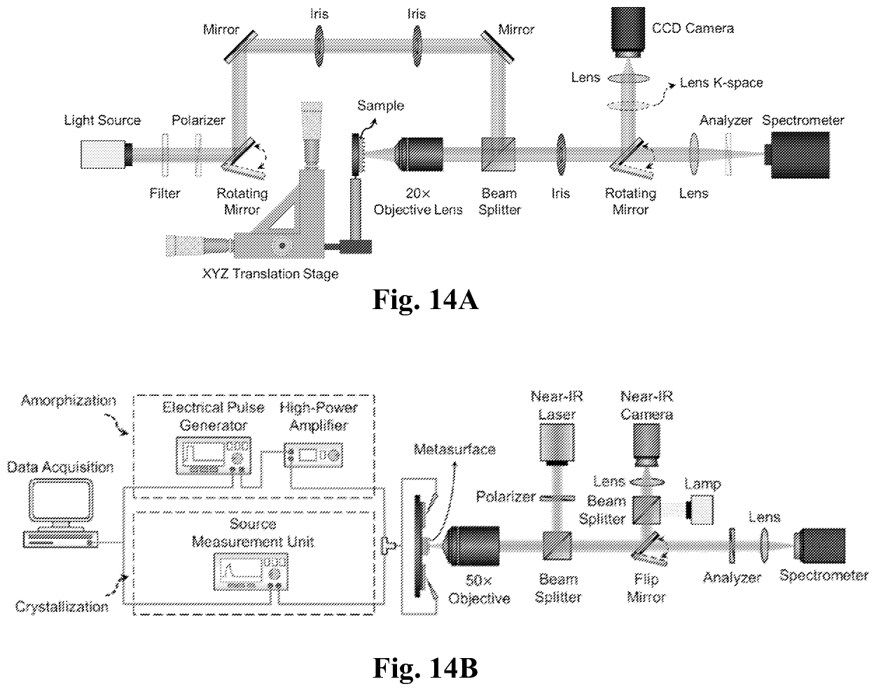

For this purpose, the dynamic hybrid metasurface shown in FIG. 5A was fabricated in an area of 50 μm×50 μm using a standard fabrication procedure including evaporation, thin-film deposition, lithography, and etching techniques. Due to the material sensitivity of PCMs, some of the processes were customized to prevent possible degradation of GST during the fabrication. FIG. 9 displays a scanning electron micrograph (SEM) of the as-fabricated tunable meta-switch. The meta-switch was optically characterized using an IR reflectometry measurement setup shown in FIG. 14A. The measured and simulated reflection spectra at normal incidence for the two extreme and one intermediate states of the meta-switch are shown with in FIGS. 10A and 10B, respectively. When the GST is in its amorphous and crystalline phases, the hybrid metasurface shows a reflection dip of ≈0.19 and ≈0.10 located at λ=1515 nm and λ=1260 nm, respectively. Given that GST in its amorphous state has the lowest extinction coefficient, the dominant effect of SPP, associated with higher energy localization in the vicinity of the Au substrate, compensates for the required loss for a deep reflection in the C-band (1530 nm<λ<1565 nm). The optimum structural parameters enable the excitation of the MD mode that relatively sustains the resonance shape of the meta-atom with GST in the crystalline state. Due to the monolithic increase in the refractive index of GST from the amorphous to the fully crystalline state, a continuous redshift of the resonance wavelength and thus, reflection dip in FIG. 10A is naturally expected. Regarding this, starting at L^{0%} (amorphous), the low-order resonance dip in FIG. 10A first progressively moves from the C-band to the L-band (1565 nm<λ<1625 nm) while it gradually vanishes, then around L^{60%} the high-order hybridized mode emerges and smoothly redshifts which finally settles at wavelengths <1260 nm for L^{100%} (fully crystalline) in the O-band (1260 nm<λ<1360 nm).

As depicted in FIGS. 10A and 10B, the experimental far-field optical responses of the hybrid meta-switch under normal illumination are in good agreement with the simulated results. The redshift between the reflection dips of the experimental and simulated spectra stems from the fabrication imperfections, angular sensitivity to the inclined excitation, partial crystallization of GST during the fabrication process, finite size of the array of meta-atoms, and discrepancy between the optical constant of fabricated materials and those used in simulations. Moreover, the cross-sectional SEMs reveal that upon conversion from amorphous to crystalline, the physical thickness of layer shrinks by 5%.

The relative absorption bandwidth of the meta-switch, defined as BW_{S(λ)}=2×(λₗ−λₛ)/(λₗ+λₛ), in which λₗ and λₛ are the long and short limits of the wavelength range with absorption above 70%, respectively, reaches about 1.3%, 1.9%, and 14.4% for the case of L^{0%}, L^{40%}, and L^{100%}, respectively. Moreover, the relative modulation contrasts in reflection (|r_{a-GST}−r_{c-GST}|/Max(r_{(a-GST, c-GST)})), with r_{a-GST} and r_{c-GST} being the reflectivity of the structure with a-GST and c-GST, respectively, and the function Max(a, b) returning the larger of a and b, are 0.56 and 0.79 at λ=1550 nm and λ=1300 nm, respectively. Assuming and representing the metasurface resonance due to all intrinsic (non-radiation) and radiation losses, respectively, the meta-switch exhibits under-coupled (i.e., Qₐ<Qᵣ) operation at the fundamental mode in the amorphous state and gradually shifts to the over-coupled regime (i.e., Qₐ>Qᵣ) upon partial-crystallization of the GST layer and finally returns to the under-coupled regime upon being fully-crystallized.

To understand the physical mechanism of light-matter interaction in each state, full-wave simulations are performed using a commercialized electromagnetic solver. The electric and magnetic near-field distributions in a cut plane perpendicular to the surface of the meta-atom at the operational wavelength associated with the reflection dips in FIG. 10B are calculated to discern the origin of hybridized modes.

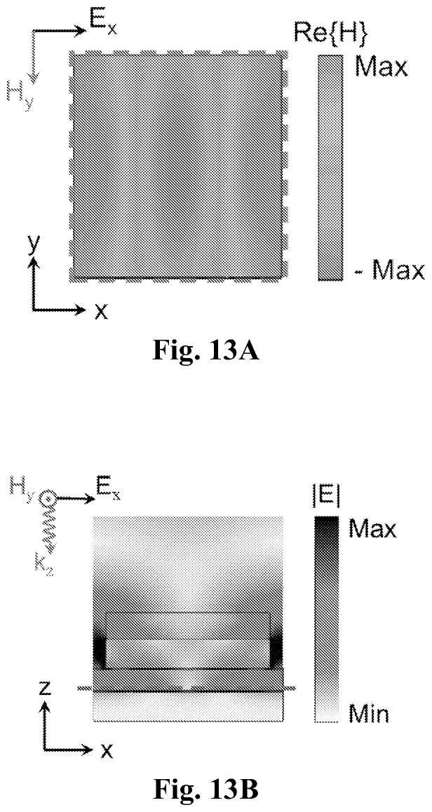

For the case of amorphous GST state, two modes coexist in the hybrid meta-atom. The dominant one is SPP that originates from the collective oscillation of free electrons in the Au substrate coupled to the scattered light (from the 2D array of Si nanodisks) with an appropriate in-plane wavevector. This mode is distinguished by a mirrored electric field that semi-circulates perpendicularly to the metal surface (see FIG. 11A and conceptual representation in FIG. 7A and a magnetic field that oscillates in the center in parallel to the substrate surface. The interference between the launched SPPs along the positive and negative x directions forms an in-plane standing wave (see FIG. 13A). The less influential mode for the a-GST case is the localized electric dipole mode associated with the high field intensity around the Si nanodisk edges (see FIG. 11A and FIG. 7A) and characterized by an anti-phase electric field distribution at the tips of the nanodisk (see FIG. 13B). It is worth to notice that due to the coupling between two neighboring nanodisks, the electric field is remarkably enhanced (over 5.8×) in the gap between the two meta-atoms.

By transforming GST to its fully crystalline state (L^{100%}), the effective wavelength of light inside the high-index pseudo-pillar becomes comparable to its size. This guarantees the excitation of the MD mode characterized by the circular displacement current of the electric field within the pseudo-pillar. FIG. 11C (and the schematic in FIG. 8A) shows that the orientation of the electric field is antiparallel at the top of the Si nano disk and the bottom of the GST layer, which is associated with maximized magnetic field at the center of the pseudo-pillar (as shown in FIG. 11C). Furthermore, the resonating horizontal MD mode at the bottom end of the pseudo-pillar results in the formation of a localized plasmonic hotspot at the surface interface of Au substrate and GST film, as depicted in FIG. 11C. Such an enhanced mode couples the surface-normal propagating plane wave to the highly attenuating SPP.

The physical mechanism of governing modes are also investigated through full-wave simulations at resonant wavelengths associated with four intermediate states of GST. Numerical results show that the metasurface in FIG. 9 demonstrates a fairly similar behavior for GST states between and semi-crystalline states up to L^{60%}, and thereafter the governing modes follow distributions relatively similar to that for the fully-crystalline state L^{100%}. For the sake of brevity, the electric and magnetic fields for the case of L^{40%} are shown in FIG. 11B, and the remaining results are provided in FIGS. 12A through 12C.

### Example 3—Dynamic Hybrid Metasurface to Control the Phase Response

The governing plasmonic-photonic modes of the meta-surface in FIGS. 2A-4A can enable dynamic phase control and wavefront engineering in a rather wide wavelength range reconfigurable beaming in the technological wavelength around 1550 nm. To prove this unique feature, the hybrid metal-dielectric meta-atom is re-optimized to simultaneously provide wide (narrow) phase span with maximized scattering efficiency in the amorphous (crystalline) state at an operation wavelength around λ=1550 nm. The meta-atom shape remains circular for polarization insensitive operation, and the structural parameters are as follows: h_{HSQ}=90 nm, h_{Si}=100 nm, h_{SiO}_{₂}=5 nm, h_{GST}=70 nm, and p=720 nm. As shown in FIGS. 15 and 16 by varying the Si nanodisk radius (i.e., r), almost full 360° optical phase coverage is achieved in the amorphous state, which is remarkable for any phase-based optical functionality. This phase profile then follows a flat trace upon transformation of a-GST to c-GST. It is notable that the reflection amplitude response of the metasurface in the a-GST case experiences considerable variation at λ=1550 nm due to the on-resonance operation of the metasurface, as shown in FIG. 15. This situation is significantly relaxed for the c-GST case due to the off-resonance operation associated with fairly flat amplitude response with a higher overall optical efficiency (see FIG. 16).

To realize dynamic beam deflection, the generalized Snell's law was exploited as defined as:

$${θ}_{r} = {sin}^{- 1} ( \frac{λΔϕ}{2 π p} + sin {θ}_{i} ) ,$$

in which θᵣ and θᵢ are the reflection and incidence angles, respectively, and Δϕ represents the phase increment between the adjacent meta-atoms (FIG. 15). A 2D array of meta-molecules having four different meta-atoms was used to introduce linear phase gradients into the incoming wavefront to scatter light to the anomalous (specular) angle when GST is in its amorphous (crystalline) state. For the case of a-GST, Δϕ≈90° is chosen associated with r₁=110 nm, r₂=155 nm, r₃=185 nm, and r₄=265 nm to facilitate constructive interference to the outgoing angle of θᵣ≈32° under normal illumination. By converting a-GST to the c-GST, all designed meta-atoms encoding step-wise phase profile to incident light serve as similar phase retarders (i.e., Δϕ≈0°). As a result, the overall optical response of the meta-deflector resembles that of a minor-like metasurface that reflects incident light to the specular angle (i.e., θᵣ=θᵢ), as shown in FIG. 15. Although the extinction coefficient of c-GST is large at this wavelength, its high complex refractive index effectively makes the device mismatched to the vacuum impedance while reducing the time of light-matter interaction, and thus alleviates the total loss.

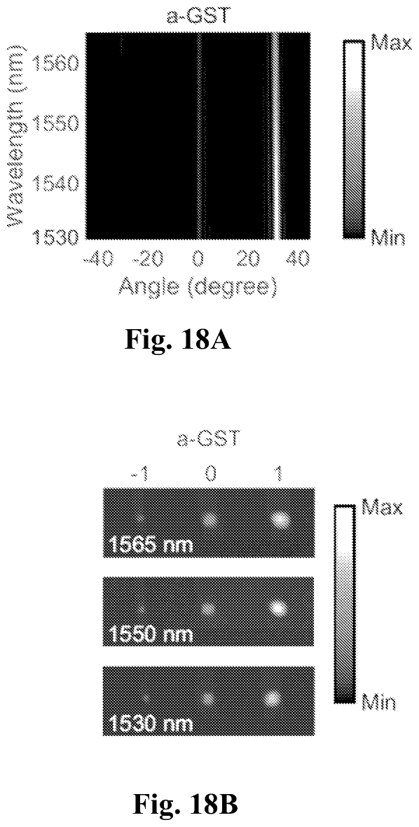

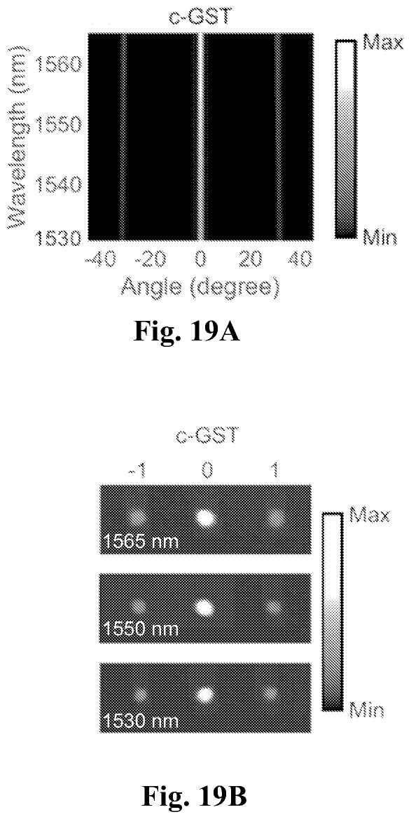

The PCM-functionalized meta-deflector was fabricated following the established techniques explained in Example 6 below, and characterized using a back focal plane imaging setup as detailed in FIG. 14A. FIGS. 18A and 19A demonstrate the 2D maps for the simulated and experimentally measured far-field angular-spectral reflection response of the meta-deflector under normal excitation for the amorphous and crystalline states of the GST layer. FIG. 18B shows that in the amorphous state, Or 30° at three different incident wavelengths in the C-band is in good agreement with the simulation results. Moreover, the overall efficiency slightly differs from the numerical simulation results. By transforming GST to the crystalline state, the meta-deflector reflects the incident light with an ordinary specular angle of θᵣ≈0° and an efficiency marginally lower than that predicted by simulations due to the excitation of symmetric first-order diffractions. In both cases, the fabrication imperfections (surface roughness, deviation from a designed shape/height, partial crystallization of GST, etc), higher material losses of the fabricated sample than that of the modeled materials, oxidation of the GST layer during the transfer process be-tween different chambers, limited extension of the array of meta-molecules, and light leakage from sample edges are the main source of discrepancy between simulation and experimental results. Further differences can likely be ascribed to the finite range of incident/collected angles and coupling of higher order modes originating from non-perfect normal excitation of the sample.

### Example 4—Manifold Learning for Sensitivity Analysis

To conduct sensitivity analysis of the dynamic hybrid metasurface upon phase conversion of GST and perform robustness study against structural variation, e.g., caused by fabrication imperfections, a nonlinear dimensionality reduction approach was leveraged, namely manifold learning. This technique provides an intuitive visual representation of the reflection spectra of the hybrid metasurface in a low-dimensional space that enables us to follow the evolution of the metasurface responses upon changes in the GST phase or the geometrical parameters in the meta-atom structure.

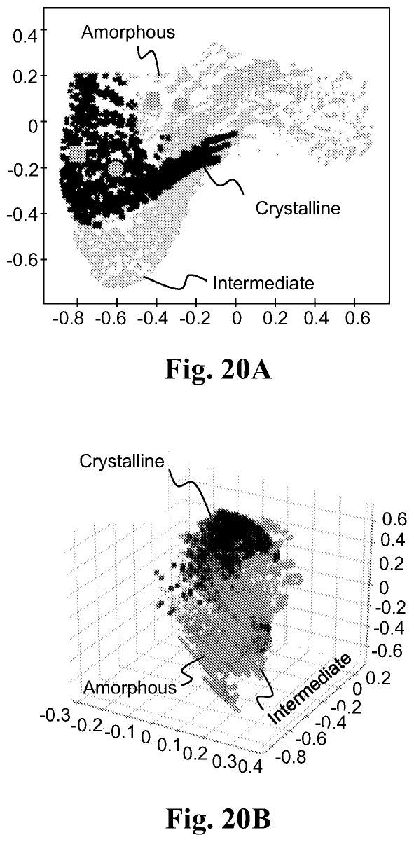

The meta-atom in FIG. 4A has six geometrical design parameters, which are r, p, h₁₆₀, h₁₂₀, h_{140, 150}, and h₁₁₀. To generate the training data for the manifold learning algorithm, the reflection spectrum of 10000 different metasurfaces with geometrical parameters selected randomly was calculated. For each set of geometrical parameters, GST with crystallization levels of L^{0%}, L^{40%}, and L^{100%} are considered. Then, each of the calculated reflection spectra is uniformly sampled at 1000 wavelengths in the desired wavelength range of 1100-1700 nm. To find the low-dimensional visual representation of the reflection spectra, the locally linear embedding (LLE) method to the 10000 reflection responses was applied. FIGS. 20A and 20B show the resulting 2D and 3D manifolds of the reflection spectral responses, respectively. Distinguishable clusters associated with the investigated GST crystallization levels can be obviously seen that render the proposed metasurface structure affords robust operational modes in any material state of GST.

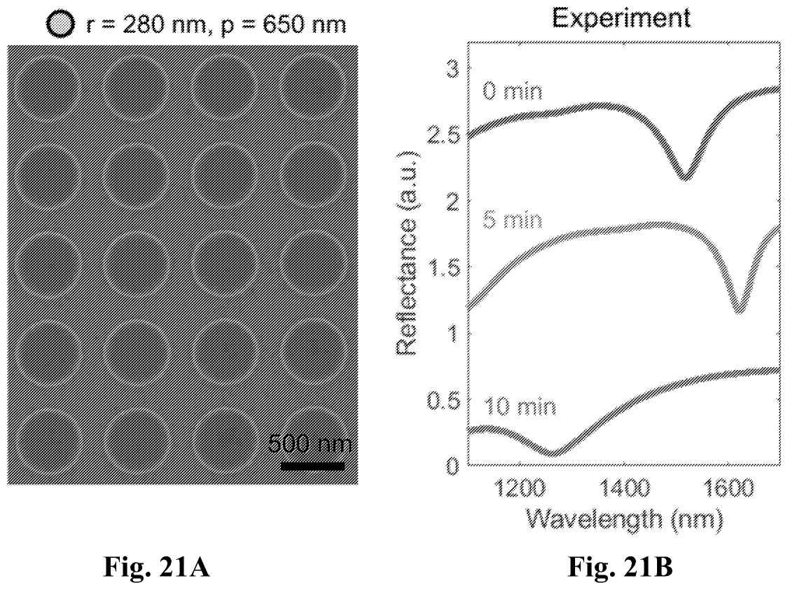

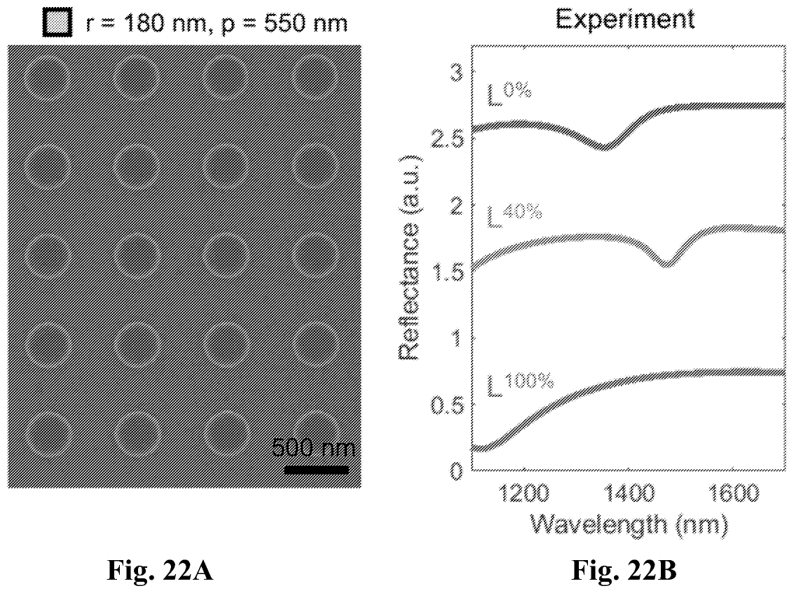

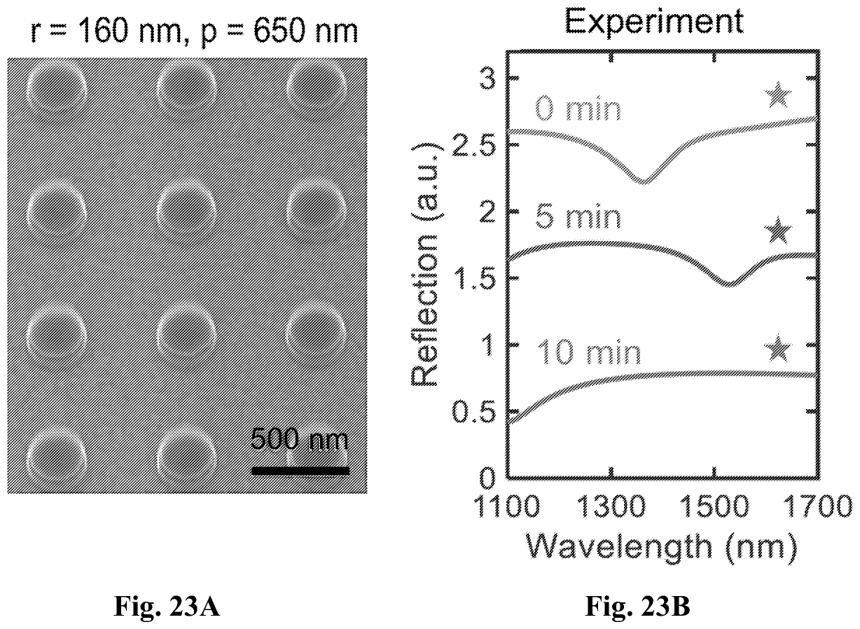

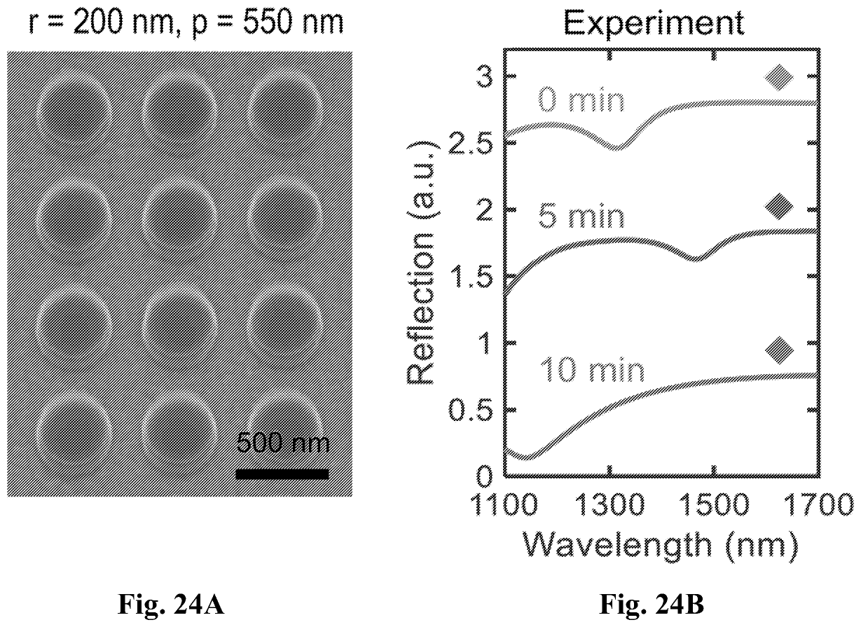

To corroborate this observation, two sets of metasurfaces with different r and p were fabricated and illustrated in FIGS. 21A and 22A. The corresponding measured reflection spectra for the cases of amorphous (L^{0%}), semi-crystalline (L^{40%}), and fully-crystalline (L^{100%}) GST states are displayed in FIGS. 21B and 22B. The low-dimensional representations of the measured spectra are depicted (with solid markers with different colors associated with different crystallization levels) in the 2D and 3D manifolds in FIG. 20A. It is evident that for a given crystallization level, the markers remain within the same manifold even though the associated geometrical parameters are different. One interpretation of these intuitive visualizations is that low-sensitivity operation of the meta-surface is owing to the nature of GST-assisted hybrid metal-dielectric combination, which fairly relaxes the effect of fabrication imperfections and even characterization tolerances. The rather good agreement between simulation results and experimental measurements through-out the paper is in-line with this observation. This insight also reveals that GST crystallization level can be considered as a dominant tuning knob to manipulate the optical response at will.

### Example 5—Numerical Simulations

All numerical simulations are carried out by using the commercial software packages CST Microwave Studio based on the finite integral technique (FIT) and COM-SOL Multiphysics based on the finite element method (FEM). For the design of meta-atoms, a unit cell boundary condition is employed which induces periodic boundary conditions in the x and y directions. Also, the perfect matched layer (PML) is considered in the z direction to mimic a free-space to monitor far-field scattering (see FIG. 25A). Simulations are performed in a 3D computational domain using a non-uniform mesh topology with hexahedral elements in all directions. The maximum element size of λ/10, where λ corresponds to the shortest wavelength in the analyzed spectral window, is chosen. A plane wave is launched into the meta-atom along the z direction, and the reflection spectrum is monitored at the input port. Electric and magnetic field distributions are detected within the frequency profile monitors. Optical properties of all materials are obtained from ellipsometry measurements (see FIG. 4C) except for Au which is described by the Lorentz-Drude model with three times damping constant larger than the bulky material. Amongst the existing effective-medium theories, the Lorentz-Lorenz relation was used to model the effective dielectric constants of GST in different crystallization levels as follows:

$$\frac{{ϵ}_{eff} ( λ ) - 1}{{ϵ}_{eff} ( λ ) + 2} = m \times \frac{{ϵ}_{c} ( λ ) - 1}{{ϵ}_{c} ( λ ) + 2} + ( 1 - m ) \times \frac{{ϵ}_{a} ( λ ) - 1}{{ϵ}_{a} ( λ ) + 2} ,$$

where for a specific wavelength (λ), ϵ_{c}(λ) and ϵₐ(λ) are the permittivity's of crystalline and amorphous GST, respectively, and m, ranging from 0 (associated with L^{0%}) to 1 (associated with L^{100%}), is the crystallization level of GST. The optical properties of GST in the intermediate states are reflected in FIG. 4C.

### Example 6—Sample Fabrication

To keep the intrinsic optical properties of the as-deposited GST film intact, an exhaustive optimization of the fabrication procedure was carried out. First, a prime Si substrate (500 μm-thick) was cleaned in acetone within an ultrasound bath; rinsed using methanol, isopropyl alcohol, and deionized water; dried using dust-free nitrogen and exposed to the oxygen plasma. A successive deposition of a Ti adhesion layer (5 nm-thick, 0.2 A s⁻¹ at 2×10⁻⁶ mbar) and an Au film (100 nm-thick, 0.3 A s⁻¹ at 2×10⁻⁶ mbar) was then carried out using the electron-beam evaporation system without breaking the vacuum. Then, the sample placed in the atomic layer deposition (ALD) chamber to thermally grow a SiO₂ film (5 nm-thick at 150° C.) using a standard two-pulse process of water and the TDMAS precursors (20 s and 60 s, respectively). In the next step, the sample was transformed to the sputtering chamber for RF magnetron deposition of a layer of GST (70 nm-thick, background pressure of 1×10⁻⁶ mbar and 45 W power under 40 sccm argon (Ar) flow). It was quickly followed by another ALD deposition process to form the second SiO₂ film (5 nm-thick at 90° C.) as a protective layer. Hydrogenated amorphous Si (a-Si) (90 nm-thick) was of silane in Ar) at low temperature to prevent crystallization of as-deposited GST. Negative electron-beam resist (hydrogen silsesquioxane (HSQ) 6%) was then spin-coated (60 s at 6000 r.p.m.) and baked (180 s at 90° C.). Then, a water-soluble anti-charging conductive polymer was spin-coated (Espacer 300Z, 30 s at 2000 r.p.m.) to avoid static charging in the patterning process. Electron-beam lithography (EBL) was performed with 100 kV acceleration voltage, 120 μm aperture, 1 nA beam current, 6.4 nm exposure step size, 2500 μC·cm⁻² dose, and 500×500 μm² writing field in an Elionix ELS-G100 system. In the next step, the anti-charging layer was removed in a water bath, and the exposed pattern was developed in a resist developer (TMAH for 30 s at 40° C.) followed by deionized-water rinsing (5 min) and nitrogen drying. The etching process was then performed using chlorine (Cl₂) gas in an inductively coupled plasma reactive ion etcher (ICP-RIE), in which a detailed optimization of the etching process was conducted to minimizing the exposure of the GST layer to the plasma while maximizes sidewall sharpness. The left-over HSQ (with the final optimized thickness) on the Si nanodisks was not removed at the end. An explanatory figure showing the fabrication steps can be found in FIG. 25B.

### Example 7—Thermal and Optical Switching Experiments

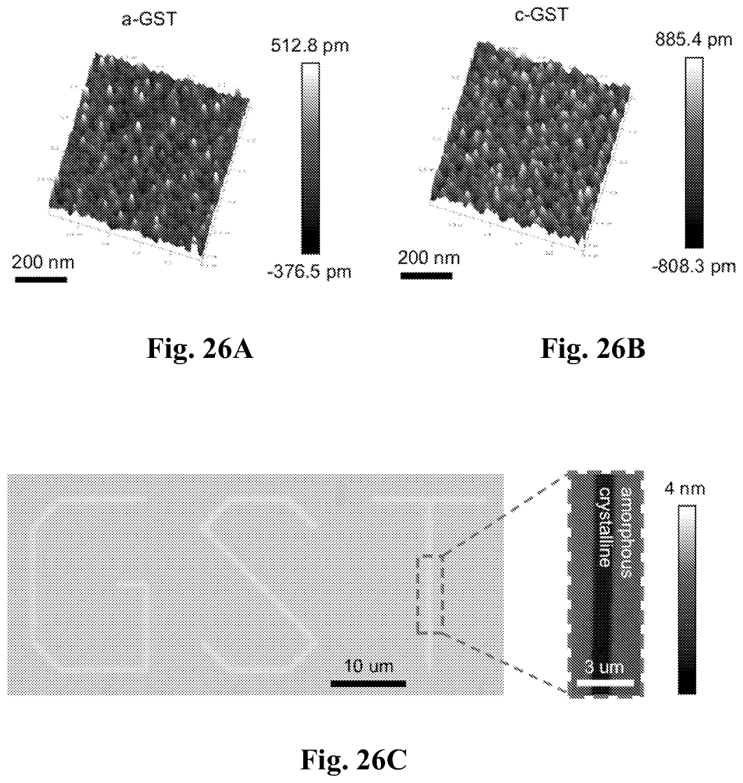

To transform the phase of GST from amorphous to semi- and fully-crystalline, the sample under test was introduced to the center of a wide hotplate with a fixed temperature of 145° C. The prescribed time for 40% and 100% crystallization levels were 5 and 10 minutes, respectively. After being heated, the sample was cooled down in the ambient, then transferred to the optical setup for the progressive reflection measurement. Sub-micron-size crystallization of a metasurface-less GST layer was demonstrated using a train of ultrashort laser pulses (using Nanoscribe GmbH) as shown in FIGS. 26A through 26C. To highlight the potential of GST as a reversible functional material, a commercialized femtosecond laser setup (Optec WS-Flex) was employed to amorphize a spot size of 15 μm on a thermally crystallized metasurface-less GST layer. The exact composition and thickness of the GST film as well as the thermal conductivity of the medium in contact with the GST layer defines the fluence of the ultrashort pulse for a uniform conversion. It was found that a single 6 nJ/μm⁻² pulse can successfully amorphize a 70-nm-thick c-GST layer.

### Example 8—Optical Characterization

The optical measurements were performed in a home-made reflectometry setup. The filtered collimated beam from a tungsten light source was coupled to an optical fiber to illuminate the 50×50 μm² pattern using a 20× objective lens numerical aperture (NA) of 0.4. The reflected light was collected and focused by a tube lens a spectrometer and a silicon CCD (charge-coupled device) camera. All the wavelength-dependent data collected by the spectrometer were normalized with respect to that of a bare silver mirror in the measurements of the meta-switch. By introducing and removing a lens K-space near the CCD (see FIG. 14A), the back focal plane of the objective lens and switch could be imaged between the real space and the Fourier plane. The bright field images were taken using a reflection microscopy setup illuminated by a white light source and equipped with a digital CCD camera. All measurements were carried out at room temperature (25° C.).

### Example 9—Material Characterization

The complex refractive index of GST thin films was determined using a Woollam Ellipsometer m2000. The spectroscopic ellipsometery measurements were performed at three angles of incidence (50°, 60°, 70°) over a spectral range from 350 nm to 1750 nm. Oscillator parameters as well as the thickness of the GST film and the surface roughness were used as fitting parameters. Tauc-Lorentz and Cody-Lorentz models were employed for the evaluation of optical functions of thin GST films in as-deposited and crystalline states. The model parameters including Lorentz oscillator amplitude, resonance energy, oscillator width, optical bandgap, and Urbach energy were chosen as fitting parameters. The surface roughness measured by atomic force microscopy (AFM) measurements in both phases was fixed in all calculations.

FIGS. 26A through 26C illustrate the 3D surface topography images using AFM for the as-deposited and fully-crystalline (using a uniform thermal process) and fully amorphous thin film of GST. The roughness of the GST film associated with the number of fine grains fairly increases by converting a-GST to c-GST. FIG. 9C shows the 2D surface image of a line (≈1 μm-wide) written with a train of optical laser pulses on a thin film of GST. The thickness of the optically phase-converted GST region appears ≈3.5 nm (≈5% out of a 70 nm-thick GST film) lower than the a-GST film due to an increase in film density by the crystallization process. The results are in good agreement with the measurements of thermally crystallized GST films.

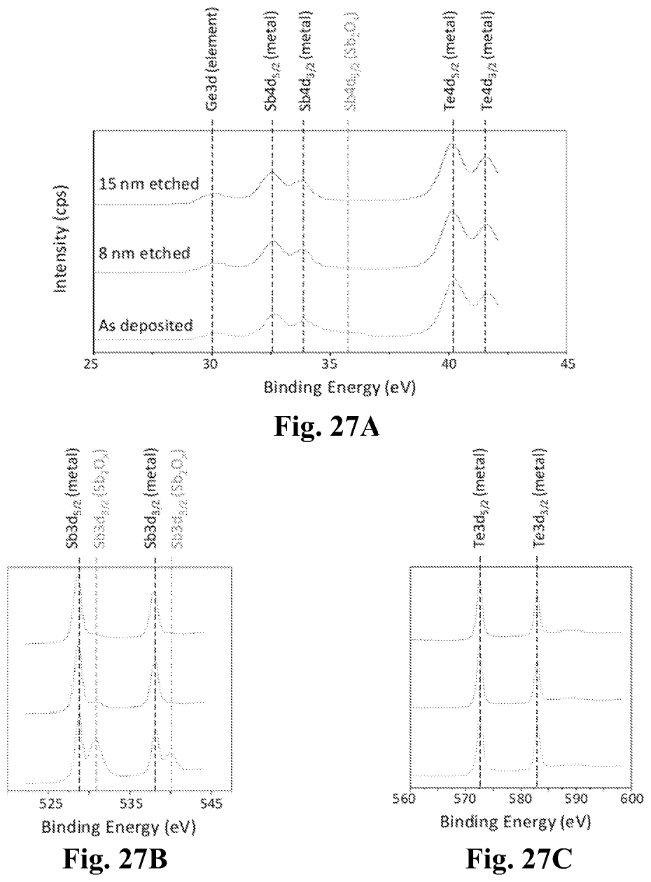

To determine the binding energies of the core electrons in a-GST films, X-ray photoelectron spectroscopy (XPS) was performed. To remove surface contamination as well as oxidation, the sample was sputtered with Ar ions with an energy of 0.5 KeV and a current density of approximately 10 μA·cm⁻² resulting in a hole size of tens of micrometers. This leads to the improvement of the intensity peaks of the main elements in the survey scan of the alloy. The survey scan was carried out within the binding energy range of 0-600 eV for different etched thicknesses, and core-level spectra of elements are plotted in FIGS. 27A through 27C.

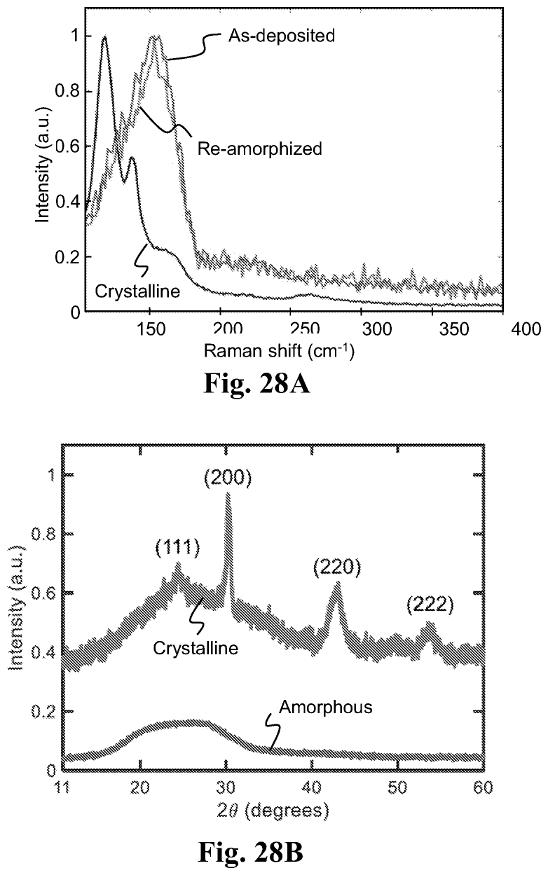

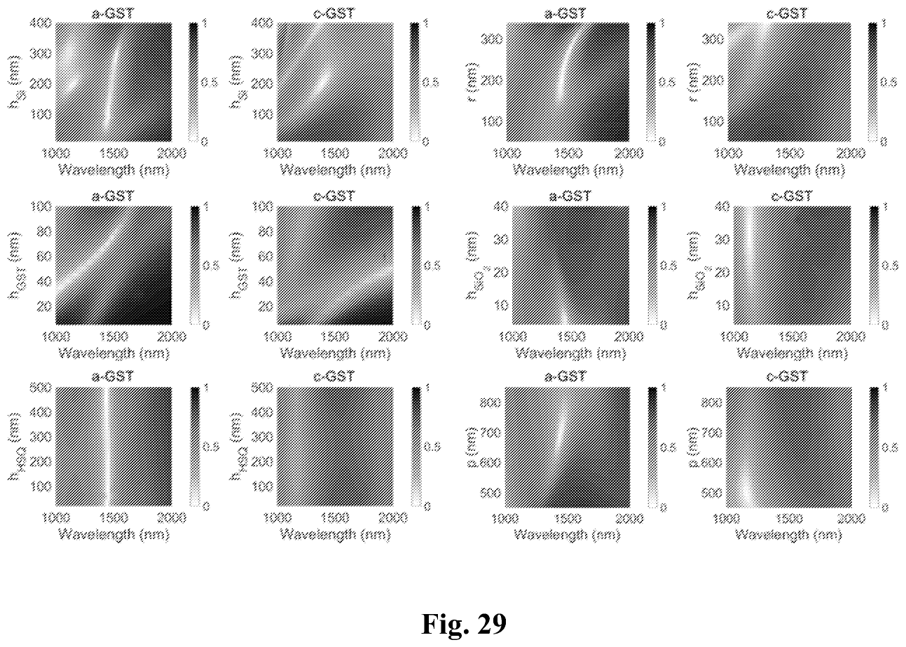

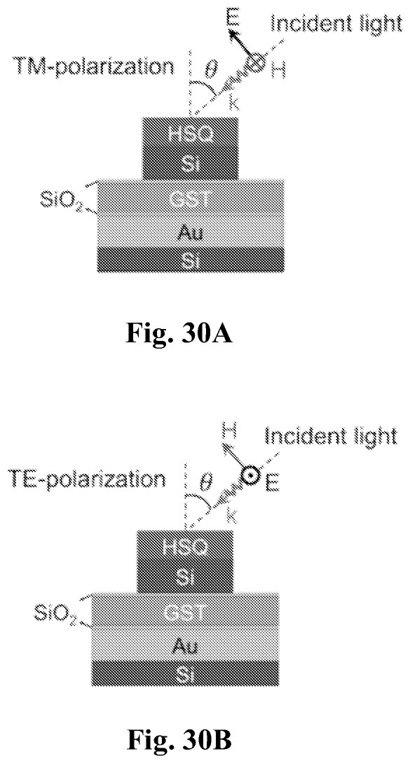

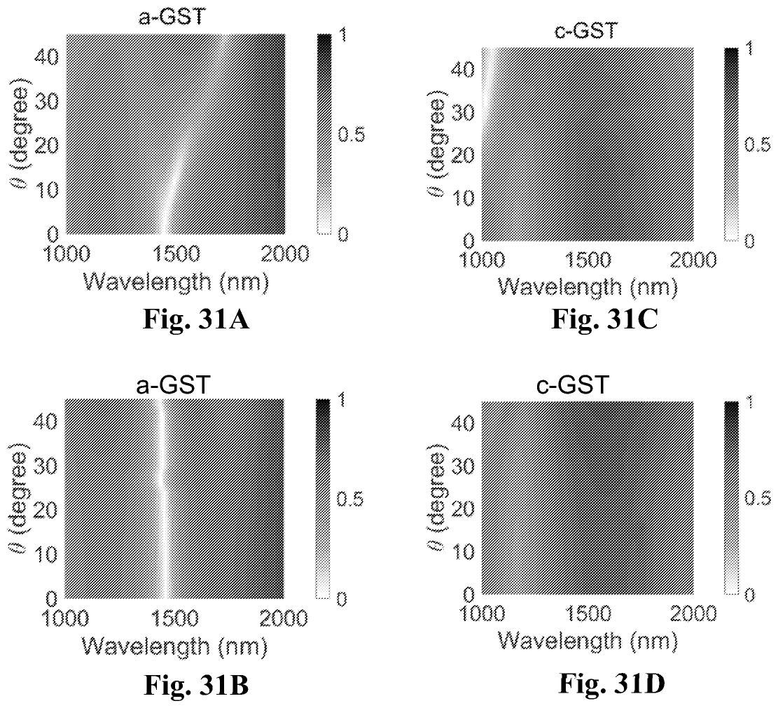

The inVia Qontor confocal Raman microscope (100× objective) was used to study the Raman scattering in the micro-Raman configuration from a thin film of GST in as-deposited, crystalline, and re-amorphized states illuminated by the primary 785 nm laser. The power and integration time were set to 0.3 mW and 10 s, respectively, in all cases to prevent unwanted crystallization and possible ablation during measurements. FIG. 28A clearly shows that the as-deposited (and amorphous) state poses a rather broad peak, which converts to a dual-band peak upon transition to the crystalline phase. These results are in good agreement with the ab initio molecular dynamic simulations and experimental results available in the literature. The sole peak in the amorphous state is due to vibrations of defective octahedra formed by Te, Sb, and a majority of the Ge atoms while the induced dual peak in the crystalline states corresponds to the larger spread in the Ge—Te and Sb—Te bond lengths.

PANalytical Empyrean diffractometer was employed to study the X-ray diffraction (XRD) spectrum of the as-deposited and fully-crystalline states of a thin film of GST. The corresponding XRD patterns of a 170 nm-thick layer of GST deposited on a Si wafer are depicted in FIG. 28B, in which the corresponding curves are shifted along the vertical axis for the sake of clarity. The XRD spectrum displayed for the crystalline state shows Bragg peaks justifying the NaCl type structure with a face-centered cubic configuration.

### Example 10—Electrothermal Analysis of Integrated Heterostructure Meta-Device

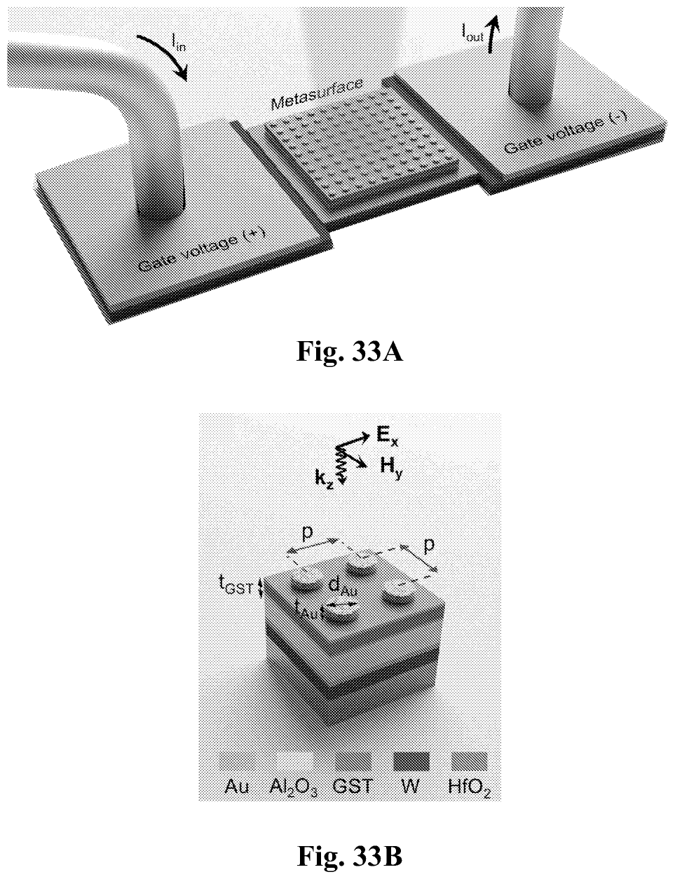

A schematic view of the reconfigurable heterostructure meta-device driven by in situ electrical pulses is represented in FIGS. 33A and 33B. The configuration of the microheater is carefully chosen to meet the design specifications within the limitation of testing equipment. It consists of a 12×12 μm² square of 50-nm-thick tungsten (W) layer connected to the top metasurface with a 20-nm-thick layer of alumina (Al₂O₃) and isolated from the silicon (Si) substrate, as a good heat sink, with a 100-nm-thick hafnia (HfO₂) film. The microheater is in contact with two 100-μm-wide gold (Au) pads to facilitate the engagement with high-frequency probes or wire bonding to an external board. Tungsten was chosen for the microheater material due to its high melting point, good thermal conductivity, moderate resistivity, and low thermally activated diffusion. While high thermal conductivity of Al₂O₃, in comparison to all existing oxides, significantly facilitates heat exchange between the microheater and the metasurface, a thick-enough HfO₂ layer helps preservation of the generated heat for GST phase change to keep the electrical power consumption low.

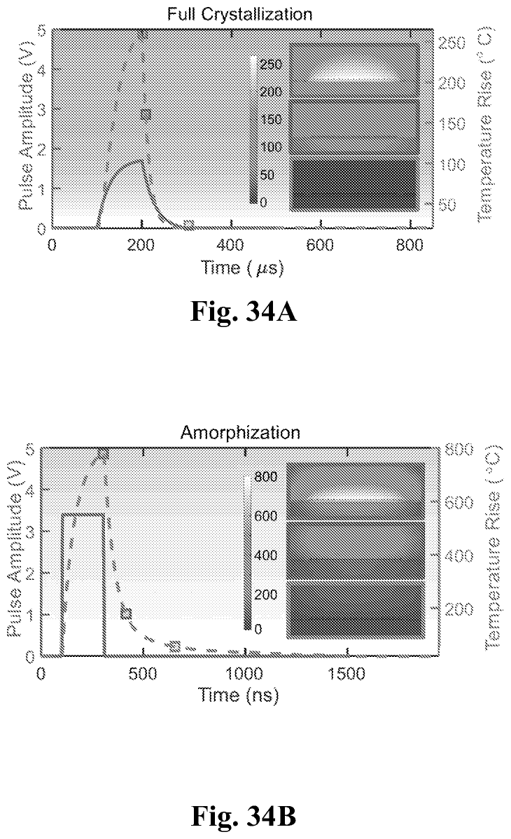

In order to study the performance of the miniaturized heater in terms of switching speed, heating/cooling rate, temperature uniformity, and energy efficiency, the real-time temperature distribution of the heterostructure meta-device in response to two kinds of electrical pulses with different temporal profiles (i.e., “set” and “reset”) were calculated. As shown in FIG. 34A, the low-voltage set pulse (with 200-μs-long double exponential waveform and a peak voltage of 1.7 V) heats amorphous GST above the crystallization temperature (˜160° C.) for a sufficiently long time to ensure adequate nucleation and formation of crystalline islands. On the other hand, a high-voltage pulse (with 200-ns-long rectangular wave-form and a peak voltage of 3.4 V) featuring very short leading/trailing edge (˜5 ns) rapidly increases the temperature of GST above the melting temperature (˜630° C.) followed by quenching such that GST solidifies in the amorphous state (see FIG. 34B). Considering the enlarged size of the microheater (one order of magnitude larger than others in the prior art), uniform heat generation over the whole volume of the GST film should be carefully addressed to ensure reliable and repeatable optical performance. The simulated two-dimensional (2D) temperature map in FIG. 34A indicates that at the end of the set pulse, the temperature difference between the center and the two ends of the metasurface is <12%. This is uniform enough to guarantee repeatable conversion of the GST film though it can be improved by increasing the clearance between the metasurface and the end of large probing pads acting as a heat sink. The data cut along the x axis reveals that the temperature gradient along the out-of-plane direction is negligible (<0.2%) due to the thinness of the GST film. These features are essential to precisely register multiple reversible intermediate phases to the GST film and enabling reprogrammable multifunctional metasurface.

The realization of sufficiently fast cooling rate is a grand challenge towards the amorphization process of PCMs. If the thermal characteristic of the microheater is modeled as a first-order system comprising a parallel thermal resistance (Rₜ) and thermal capacitance (Ce), the cooling rate follows an exponential relation with a time constant of Σ=Re and Ce depend on the length and the width of the microheater as well as the thermal properties of the ambient. Therefore, to speed up the meta-device transient response, an optimized selection of material and geometry for both the microheater and the surrounding medium is indispensable. As depicted by electrothermal simulations in FIG. 34B, the heterostructure with an elevated temperature of 790° C. at the end of the reset pulse is cooled down with the rate of −10° C./ns to <480° C. and −6° C./ns to <160° C., which is higher than typical 1° C./ns melt-quenching criterion

### Example 11—Design of the Phase-Change Metasurface

The high potential of phase-change metasurfaces in engineering the optical scattering is revealed by exploring the near-field light-matter interaction mechanisms within a hybrid plasmonic-PCM meta-atom. Through a set of theoretical calculations and full-wave electromagnetic simulations, the evolution of governing surface plasmon polariton (SPP) modes and the intricate coupling processes between them are investigated upon the phase transition of GST from amorphous (a-GST) to intermediate or partial crystalline (p-GST) and ultimately to full crystalline (c-GST).

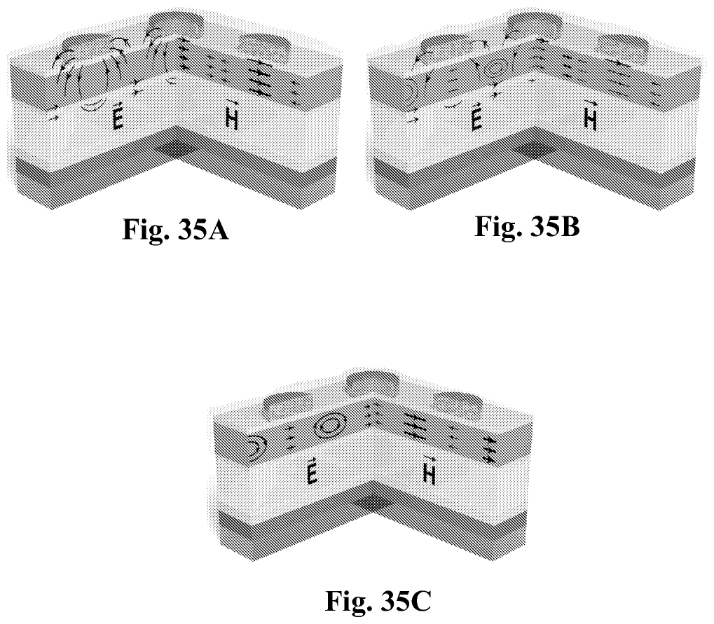

The 10.5×10.5 μm² phase-change metasurface comprises 35-nm-thick Au nanodisks separated from an 80-nm-thick Au backreflector by a 40-nm-thick blanket film of GST sandwiched between two 10-nm-thick layers of Al₂O₃. Two Al₂O₃ layers prevent heating-induced oxidation of the GST film and diffusion of the noble metal into GST during the heating process. In the case of a-GST with low intrinsic loss, the hybrid plasmonic-PCM meta-atom supports two spectrally distant SPP modes, namely long-range SPP (LR-SPP) and short-range SPP (SR-SPP). The theoretically calculated spectral locations of the former and the latter are displayed by white and black dashed lines, respectively. Partial crystallization of GST draws the slightly broadened modes to the center of the telecom spectral window, i.e., 1260-1650 nm, where they fairly overlap. By fully converting the state of GST using electrical Joule heating, a significant index contrast can be observed, which further broadens and dampens the existing resonance modes. The spatial characteristics of the LR-SPP and SR-SPP modes due to the excitation of SPPs at the infinite interface of the Au back reflector and the bottom Al₂O₃ layer and that at the individual nanodisk and the top Al₂O₃ layer are schematically illustrated in FIGS. 35A through 35C. The electric and magnetic flow-lines in FIG. 35B reveal the existence of a hybrid mode due to the overlap between the localized SR-SPP and distributed LR-SPP modes. The rich physical properties and distinct characteristics of governing modes coupled to the available state of GST offer a good degree of freedom for realization of multifunctional metasurfaces. Particularly, the evolution of the governing mode from SR-SPP in a-GST (with higher plasmonic and lower photonic loss) to overlapped SR-SPP/LR-SPP in p-GST (with balanced plasmonic and photonic losses) and finally to LR-SPP in c-GST (with lower plasmonic and higher photonic loss) facilitates manipulation of both amplitude and phase properties of light in the telecom wavelengths.

### Example 12—Dynamic Multistate Meta-Switch Characterization

The rich nature of the SPP modes and large index contrast of GST were leveraged for the demonstration of an electrically driven multispectral meta-switch. A meta-switch can be mounted on a ceramic carrier chip to facilitate packaging and external computerized bias control. A home-built linear reflectometery setup coupled to two signal generators for co-located electrical excitation and optical measurement of fabricated samples is shown in FIG. 14B.

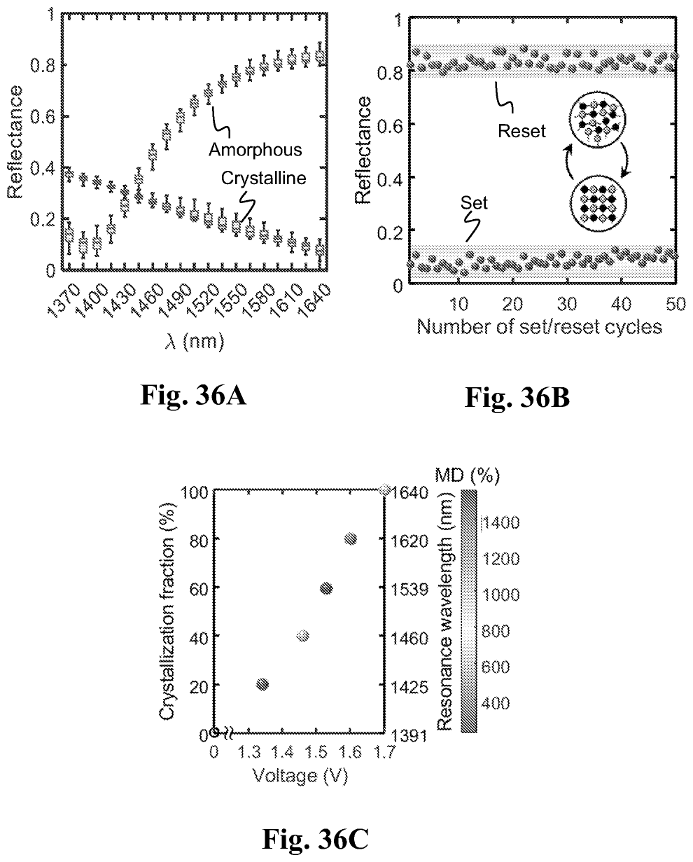

The structural design parameters of the metasurface are judiciously chosen to keep fundamental resonances of the meta-switch at the two extreme cases of GST far apart, which guarantees high modulation depth over a wide spectral bandwidth. To corroborate the design strategy, the statistical distribution of experimentally measured reflectance spectra over 50 cycles of crystallization-amorphization is displayed in FIG. 36A. The narrow boxes reveal the slight deviation of the first and the third quartiles from the median of sampled data for 15 discrete wavelengths in the telecom range. It is evident that the resonance wavelength of the meta-switch red shifts from 1391 nm with a-GST to 1640 nm with c-GST. Upon this transition, an average absolute (ΔR=|R_{a-GST}−R_{c-GST}|) and relative modulation depth (ΔR/R_{c-GST}) over 75% and 1000% are achieved at 1640 nm, respectively. More importantly, with average 82% reflectance in the reflective state, the platform surpasses the state-of-the-art electrically tunable PCM meta-switches. For more clarity, time-dependent traces of the change in the reflectance at 1640 nm during consecutive cycles of switching are depicted in FIG. 36B. The measured 95% confidence intervals (shaded areas) of ±1% and ±7.5% for the reflective and absorptive state, respectively, verify the highly reproducible switching process. Such consistent characteristics is also verified through confocal Raman microscopy by studying the micro-Raman scattering from the meta-switch under test. The non-deterministic behavior of the absorptive and reflective state stems from formation of non-homogeneous crystalline regions during heating and stochastic recrystallization of small islands in GST during the quenching process, respectively. Considering the fast relaxation time of GST and small thermal time constant and temperature nonuniformity of the heterostructure meta-device, an operation speed of a few kHz with order-of-magnitude lower operational voltages is expected.

Besides the binary-level switching, distinctive and stable intermediate phases of GST, in virtue of its giant index contrast, non-volatile, and nucleation-dominant characteristics, hold the promise for multi-state switching operation. Considering the good thermal uniformity across the microheater, precise control of the crystalline fraction of GST, through formation of critical nuclei and their subsequent growth, can be realized by applying a customized electrical pulse. This capability is explored by programming the meta-switch with consecutive fixed length pulses with different voltages. The measured reflectance of the meta-switch for a-GST, c-GST, and 4 accessed intermediate phases of GST show quasi-continuous tuning of the fundamental resonances (i.e., LR-SPP and SR-SPP) from ˜1391 nm to ˜1640 nm. With such record optical contrast, unprecedented ultrawide spectral tuning range, and potential fast switching operation, the example platform described herein outperforms many existing works relying on electro-optical, electro-mechanical, and thermo-optic effects.

To quantitatively analyze the crystallization kinetics upon electrical pulse excitation, the measured reflectance spectra was compared with simulated ones for different crystallization fractions of GST with optical properties approximated using an effective medium theory. A good agreement is observed between the color-coded experimental measurements and simulated results from intermediate states with ˜20% crystallization steps. FIG. 36C depicts the correlation between the measured applied pulse voltage, resonance wavelength of the meta-switch, and approximated crystallization fraction. Evidently, a wide spectral tuning range is achieved upon multi-state conversion of GST using electrical pulses with small voltages. The crystallization fractions of GST was quantitatively investigated in different intermediate states as a function of the induced temperature.

To study the physical mechanism behind the operation of the meta-switch, the electromagnetic field distribution was calculated at the two dips of the reflectance spectrum for the intermediate case with 80% crystallization fraction. The field profiles in the x-z cross section of a meta-atom show excitation of the SR-SPP mode and LR-SPP mode for λ₁=1407 nm and λ₂=1600 nm, respectively. The two SPP modes do not exhibit the same degree of localization and enhancement. For the former case, the magnetic field is distributed along the interface of the Au back reflector and the bottom Al₂O₃. For the latter, the magnetic field is strongly enhanced underneath the nanodisk due to the anti-symmetric current distribution in the two Au parts. The electric field magnitude profile (and flow-lines of the Poynting vector) implies that a good portion of the incident energy is dissipated after funneling of the incident wave into the lossy GST film at λ₁. In contrast, the coupling of accumulated charges at both lateral end-faces of the nanodisk can form a pronounced electric dipole resonance at λ₂. Such a strong resonance fairly traps the major energy of incident light near the nanodisk that is dissipated due to the lossy nature of Au.

### Example 13—Performance Analysis Using Machine Learning

Beyond formal modeling of any physical phenomenon, exploratory analysis with diagrammatic representations is a powerful tool that helps inferring by visualization of the data. The key concept is to form an easy-to-interpret low-dimensional representation of the structured data with the end goal of unveiling data points with unusual attributes, demystifying the underlying connections, and revealing the governing patterns. In this regard, to gain an intuitive understanding of the overall performance of the meta-switch, without relying on the apriori knowledge, data visualization is leveraged using an unsupervised machine learning approach. This method transforms a set of high-dimensional data sets (e.g., high-resolution reflectance spectra in both a-GST and c-GST states of the meta-switch) into low-dimensional maps while preserving necessary information (e.g., nature of the governing mode). A nonlinear dimensionality reduction technique called t-distributed stochastic neighbor embedding (t-SNE) was used for data exploration and visualization of high-dimensional data in image processing. The t-SNE algorithm aims to match neighbors in a higher-dimensional space to a lower-dimensional one by measuring the similarity between pairs of variables. It then optimizes these two similarity measures based on a predefined cost function. Upon applying to a high-dimensional but well-clustered data set, t-SNE tends to generate a visual embedding with distinctly isolated clusters.

Numerical simulations were carried out in the operational spectral range, i.e., 1370-1640 nm, for 3600 different metasurfaces with a wide range of randomly selected values for the structural parameters (i.e., p, d_{Au}, t_{GST}, and t_{Al2O3}) in both cases of a-GST and c-GST. Two widely unfolded clusters corresponding to a-GST and c-GST were extended over the 3D latent space. This implies that incorporation of GST in the meta-atom considerably spans the attainable responses not accessible through just variation of structural parameters with one GST state. Accordingly, the GST crystallization state can be considered as an ideal tuning knob to substantially modify the meta-device performance. Furthermore, the minimum overlap between these clusters suggests that metasurfaces with a-GST and c-GST are governed by modes with distinct natures.

While the t-SNE algorithm provides a helpful visualization of the range of responses upon changing each design parameter, it is not straightforward to use it to compare the importance of the different design features in varying the optical response. Such information is crucial in various aspects: (i) it provides valuable insight about the robustness of switching operation against variation of each design parameter, (ii) it can be used to devise non-uniform sampling of the overall range of different design parameters to form the (random) training dataset for considerably reducing the computation requirements, and (iii) it identifies the most vulnerable parameters to the fabrication errors to help in customizing the optimal fabrication process. The shortcoming of t-SNE as well as other nonlinear dimensionality-reduction (sometimes known as feature transformation) algorithms is that the dimensionality-reduced variables (or bases) in the latent space are complex nonlinear combinations of all input (or design) parameters. To address this issue and enable the benefits of ranking the importance of design parameters, feature-selection algorithms can be used. A supervised approach, namely the wrapped method, was employed utilizing a machine learning algorithm with the cost function properly defined to rank the most effective design parameters in achieving the maximum relative modulation depth in the spectral range of 1370-1640 nm. Starting from an empty feature subset, the algorithm sequentially adds each of the structural parameters as a candidate to the subset and performs cross-validation by repeatedly calculating the evaluation criterion until the stopping condition is reached.

By implementing the wrapping algorithm on the training dataset of the metasurface structures described herein, the most influential design parameters were determined to be (in the high-to-low order) t_{GST}, d_{Au}, p, and t_{Al2O3}. It was assumed that the crystalline state of GST was fixed and the same ranking for a-GST, p-GST, and c-GST. The conclusions are supported by the properties of the electromagnetic modes of the structure. Variation of t_{GST} significantly affects the spectral evolution of both SR-SPP and LR-SPP modes, where the anti-crossing behavior can occur due to pronounced coupling of these two modes. The enhancement of the induced magnetic dipole underneath the nanodisk and the coupling strength of the incident light to the in-plane wave are closely linked to this design parameter. In addition, the more sensitivity of the optical performance of the metasurface to the characteristics of SR-SPP, which is mainly influenced by changes in d_{Au}, than those of the LR-SPP, was basically governed by changes in p. Variation of t_{Al2O3} negligibly affected the overall optical performance of the metasurface.

### Example 14—Sample Preparation

The electrically driven reprogrammable metasurface was implemented through a series of standard and customized fabrication processes. Atomic layer deposition (ALD) of a 100-nm-thick HfO₂ layer was positioned on a 500-μm-thick Si substrate to prevent direct contact between the microheater and probing pads and the base substrate. Next separate steps involve electron beam (e-beam) lithography to define the patterns of the microheater/probing pads followed by e-beam evaporation of a 50-nm-thick W layer/a 100-nm-thick Au layer and ultimately a lift-off process. Then, e-beam lithography was performed to define the aperture on the microheater where the metasurface was finally located. Sequential depositions of a 20-nm-thick Al₂O₃ layer by ALD, an 80-nm-thick Au layer by e-beam evaporation, and a 10-nm-thick Al₂O₃ layer by ALD are performed to fill the opening. It follows by the deposition of a 40 nm-thick GST layer from a stoichiometric target in an RF-sputtering system and subsequent deposition of a 10-nm-thick Al₂O₃ as a capping layer in the ALD chamber. After the lift-off process, spin coating of a thin layer of polymethyl methacrylate (PMMA) is performed and Au nanodisk arrays are lithographically defined and formed by developing in a room-temperature methyl isobutyl ketone/isopropyl alcohol (MIBK/IPA) mixture. As the last step, e-beam evaporation of a 35-nm-thick Au layer was carried out followed by an overnight lift-off process. An ultrathin layer of Titanium (Ti) was used as the adhesion for Au.

### Example 15—In Situ Electrical Characterization

Full crystallization and amorphization processes were performed by applying a 1.7 V set pulse with 200-μs-long double exponential waveform and a 3.8 V reset pulse with 200-ns-long rectangular shape, respectively, to the meta-switch. The short pulse used in the latter biasing scheme avoids unwanted material flow during amorphization. Small differences with simulated results were mainly attributed to the discrepancy between the thermal properties of fabricated and simulated materials, the parasitic resistances associated with the probing pads and contacts, random resistance variation of the W patch, and the thermal boundary resistance between contributed materials. Electrical pulses with lower peak voltages than that of the set pulse were also used to transform the state of GST between its extreme phases in multiple states. The voltage pulses features zero width and leading/trailing edge of 100 μs resolution imposed by the limitations of the source measurement unit (Keithley 2614B). The reset pulse has a leading/trailing edge of ˜10 ns that was generated by Tektronix AFG3252C function generator and delivered to ENI 510L RF power amplifier before applying to the device.

### Example 16—In Situ Optical Measurements

Experimental optical measurements were performed by directly measuring the intensity of the reflected light from the surface of the fabricated device (see FIG. 14B). A low-power beam (to prevent the conversion of GST during measurements) from a fiber-coupled light source was focused on the device using a 50× objective lens. To measure the reflected signal a beam splitter was installed right before the surface of the sample to allow separation of the incident and the reflected signals. Normalization was done by dividing the intensity of a reference beam with the same spot size reflected from a smooth surface of an Au patch fabricated near the meta-device under test. To visualize the device under test, a second beam splitter was used in the optical path to direct the reflected visible light to a near-IR charge-coupled device camera. Co-located in situ optical and electrical measurements were carried out while the meta-device under the microscope was connected to the external signal generators with a high frequency Infinity probe.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A system comprising:
a phase change material configured to reversibly transform between a first state and a second state upon a triggering event and abutting a dielectric material on a first surface of the phase change material and a plasmonic material on an opposing second surface of the phase change material;
wherein one or more:
the phase change material in the first state comprises a first refractive index, the phase change material in the second state comprises a second refractive index, and the first refractive index is different than the second refractive index;
when light travels through the system the phase change material is configured to modulate an amplitude of light in a wavelength range when in the first state, and the phase change material is configured to modulate the amplitude of light in the wavelength range when in the second state, wherein the first state of the phase change material modulates the amplitude of light in the wavelength range different than the second state;
the phase change material is further configured to transform to one or more intermediate states between the first state and the second state, wherein each of the one or more intermediate states comprises a refractive index different than the first and second refractive indices;
the triggering event comprises heat, current, voltage, or electromagnetic field directed to the system; and/or
the phase change material comprises a height ranging from about 20 nm to about 200 nm, the dielectric material comprises a height ranging from about 50 nm to about 250 nm, and the plasmonic material comprises a height ranging from about 80 nm to about 200 nm.

2.-9. (canceled)

10. The system according to claim 1 further comprising a first protective layer located at the first surface between the phase change material between the phase change material and the dielectric material.

11. The system according to claim 10, wherein the first protective layer comprises a height ranging from about 5 nm to about 50 nm.

12. The system according to claim 1 further comprising:
a second protective layer located at the second surface of the phase change material between the phase change material and the plasmonic material.

13. The system according to claim 12, wherein the second protective layer comprises a height ranging from about 5 nm to about 50 nm.

14. The system according to claim 12 further comprising:
a third protective layer bordering the dielectric material on an external surface opposite the phase change material.

15. The system according to claim 14, wherein the third protective layer comprises a height ranging from about 30 nm to about 150 nm.

16. A system comprising:
a phase change material configured to reversibly transform between a first state and a second state upon a triggering event and abutting a dielectric material on a first surface of the phase change material and a plasmonic material on an opposing second surface of the phase change material;
wherein the dielectric material is arranged in an array of nano-scatterers on the first surface of the phase change material.

17. The system according to claim 16, wherein the array of nano-scatterers have a period ranging from about 100 nm to about 1000 nm.

18. The system according to claim 16, wherein the array of nano-scatterers have a radius ranging from about 10 nm to about 500 nm.

19. The system according to claim 16, wherein the phase change material is selected from the group consisting of:
a solid-solid phase change material;
a material comprising a combination of germanium, antimony, and tellurium;
a material comprising a combination of germanium, antimony, selenium, and tellurium;
a material comprising a combination of two or more materials from the group consisting of germanium, antimony, tellurium, selenium, indium, titanium, gallium, bismuth, tin, copper, lead, palladium, silver, sulfur, vanadium, and gold;
a polymeric solid-solid phase change material;
a material comprising a combination of two or more materials selected from the group consisting of polystyrene, cellulose, poly(ethylene glycol), styrene acrylonitrile, poly(styrene-co-allyalcohol), sorbitol, dipentaerythritol, inositol, melamine, formaldehyde, polyethyl eneglycol, polyethylene oxide, carboxymethyl cellulose, polyvinyl alcohol, and poly(polyethylene glycol methyl ether methacrylate); and
an organometallic solid-solid phase change material.

20.-25. (canceled)

26. The system according to claim 16, wherein the dielectric material is selected from the group consisting of silicon, silicon carbide, silicon nitride, aluminum nitride, germanium, alumina, gallium nitride, hafnium oxide, zirconium oxide, titanium dioxide, indium tin oxide, lithium niobate, silicon dioxide, gallium phosphate, gallium arsenide, hafnium silicate, zirconium silicate, strontium titanate, barium titanate, barium strontium titanate, calcium copper titanate, silsesquioxane, hydrogen silsesquioxane, octadimethylsiloxysilsesquioxane, poly(methylsilsesquioxan), poly(hydridosilsesquioxane), polyethylene, polypropylene, polystyrene, and polytetrafluoroethylene.

27. The system according to claim 16, wherein the plasmonic material is a metal selected from the group consisting of gold, silver, aluminum, bismuth, copper, palladium, titanium, and tungsten.

28. The system according to claim 16, wherein the plasmonic material is a material selected from the group consisting of titanium nitride, indium phosphide, aluminum-zinc-oxide, gallium-zinc-oxide, indium-tin-oxide, and indium nitride.

29. The system of claim 1 further comprising:
the dielectric material; and
the plasmonic material;
wherein the dielectric material comprises an array of structures positioned over a metal substrate comprising the plasmonic material; and
wherein the phase change material forms a phase change material layer configured to interface with the array of structures and reversibly transition, upon the triggering event, from the first state, along a series of intermediate states, to the second state.

30. The system according to claim 29, wherein the array of structures include:
a first row of structures comprising a first radius; and
a second row of structures comprising a second radius, wherein the first radius is different than the second radius.

31. The system according to claim 29, wherein:
the phase change material layer in the first state comprises a first refractive index;
the phase change material layer in the second state comprises a second refractive index; and
the phase change material layer in an intermediate state comprises a refractive index different than the first and second refractive indices, where the first refractive index is different than the second refractive index.

32. The system according to claim 29, wherein:
when light travels through the system, the phase change material layer in the first state is configured to modulate a phase of light in a wavelength range; and
the phase change material layer in the second state is configured to modulate the phase of light in the wavelength range;
wherein the first state of the phase change material layer modulates the phase of light in the wavelength range different than the second state.

33. The system according to claim 32, wherein:
when light travels through the system, the phase change material layer in the first state is further configured to shift the phase of the wavelength of light by an increment of about 90 degrees.

34. The system according to claim 32, wherein the wavelength of light ranges from about 1530 nm to about 1565 nm.

35. The system of claim 29, wherein the triggering event comprises heat, current, voltage, or electromagnetic field directed to the system.

36. The system according to claim 29, wherein:
the array of structures comprises a height ranging from about 50 nm to about 250 nm;
the phase change material layer comprises a height ranging from about 20 nm to about 200 nm; and
the metal substrate comprises a height ranging from about 80 nm to about 200 nm.

37. The system according to claim 29 further comprising:
a first protective layer located between the first surface of the phase change material layer and the array of structures; and
a second protective layer located between the second surface of the phase change material layer and the metal substrate.

38. The system according to claim 37, wherein the first protective layer and the second protective layer each independently comprise a height ranging from about 5 nm to about 50 nm.

39. The system according to claim 38 further comprising a third protective layer bordering the array of structures.

40. The system according to claim 39, wherein the third protective layer comprises a height ranging from about 30 nm to about 150 nm.

41.-43. (canceled)

44. A system comprising:
an array of meta-atoms positioned over a plasmonic substrate;
wherein each meta-atom comprises a dielectric nanodisk positioned over a phase change material.

45.-58. (canceled)

59. A method for manufacturing a system comprising:
providing a plasmonic substrate;
depositing a phase change material over the plasmonic substrate;
depositing a dielectric material over the phase change material;
exposing, through etching, at least a portion of the phase change material and plasmonic substrate; and
forming, through etching, the dielectric material into an array of pillars.

60.-63. (canceled)
